(19) United States
(12) Patent Application Publication
(10) Pub. No.: US 2026/0258567 A1
(43) Pub. Date: Sep. 3, 2026

(54) METHODS FOR TRANSFORMING SILICATE-CONTAINING MATERIALS INTO MATERIALS FOR CO2 REMOVAL AND OTHER APPLICATIONS

(71) Applicants: Massachusetts Institute of Technology, Cambridge, MA (US); The Board of Trustees of the Leland Stanford Junior University, Stanford, CA (US)

(72) Inventors: Yogesh Surendranath, Cambridge, MA (US); Wei Lun Toh, Cambridge, MA (US); Matthew Kanan, Stanford, CA (US); Rishi Gupta Agarwal, Menlo Park, CA (US); Benjamin Peter Charnay, Stanford, CA (US); Yuxuan Chen, Stanford, CA (US); Joshua Avraam Rabinowitz, Menlo Park, CA (US)

(21) Appl. No.: 18/878,743

(22) PCT Filed: Jun. 29, 2023
(86) PCT No.: PCT/US2023/026567

§ 371 Date: Dec. 24, 2024

Related U.S. Application Data
(60) Provisional application No. 63/367,222, filed on Jun. 29, 2022.

(51) Int. Cl. C25C 1/02; C01B 32/60; C25B 1/04; C25C 7/04

(52) U.S. Cl. CPC C25C 1/02; C01B 32/60; C25B 1/04; C25C 7/04

(57) ABSTRACT

Disclosed herein is a method of forming a precipitate, comprising: (a) providing a salt solution; (b) performing electrochemical reactions in the salt solution to produce a solution of lower pH and a solution of higher pH; (c) providing a silicate-containing material containing Mg²⁺ and/or Ca²⁺ ions; (d) treating the silicate-containing material with the solution of lower pH to dissolve at least a portion of the silicate-containing material and generate a second solution with higher pH; (e) combining the solution generated in (d) with at least a portion of the solution with higher pH generated in (b) to form the precipitate and a second salt solution; and (f) recycling the second salt solution generated in step (e) by adding (b).

### RELATED APPLICATIONS

This application claims benefit of priority to U.S. Provisional Patent Application No. 63/367,222, filed Jun. 29, 2022.

### GOVERNMENT SUPPORT

This invention was made with government support under Award number DE-SC0021633 from the U.S. Department of Energy, Office of Science, Basic Energy Sciences. The government has certain rights in this invention.

### BACKGROUND

Naturally occurring silicate-containing rocks with Mg²⁺ and/or Ca²⁺ cations react with CO₂ from the air and H₂O to form bicarbonate solutions (Ca(HCO₃)₂, Mg(HCO₃)₂) and carbonate minerals (CaCO₃, MgCO₃) that are stable for hundreds of thousands to millions of years in the geosphere. This natural process, which is known as rock weathering, is thought to remove up to ~1 Gton of CO₂ from the air each year and is an important part of the natural carbon cycle. There are enormous geological reserves of ultramafic or mafic rocks that provide the capacity to remove thousands of Gton of CO₂. In addition, there are estimated to be multiple Gton of mine tailings, which are finely ground silicate-containing materials that are waste products of the mining industry, sitting in large open pits. These natural and unnatural reserves contain orders of magnitude more base equivalents than what is needed to lower the atmospheric CO₂ concentration to any arbitrary desired level. However, the rate of natural silicate weathering is far too slow to provide additional carbon dioxide removal (CDR) to counteract human GHG emissions on the timescale needed to impact global temperature rise. There is a need for methods and systems that transform these silicate-containing materials into materials that react more rapidly with CO₂ using a low energy input so that these vast resources can be utilized for CDR.

### SUMMARY

This Summary introduces a selection of concepts in simplified form that are described further below in the Detailed Description. This Summary neither identifies key or essential features, nor limits the scope, of the claimed subject matter.

### Electrochemical Cell

In some embodiments, the electrochemical cell used to convert the salt solution into an acidic solution and a basic solution comprises an electrohydrolysis cell.

In some embodiments, the electrochemical cell comprises a bipolar membrane electrodialysis cell.

In some embodiments, the electrochemical cell comprises an anode and cathode in contact with a salt solution.

In some embodiments, the anode and the cathode are present in separate chambers of the electrochemical cell separated by one or more ion-permeable separators.

In some embodiments, the electrochemical cell has a continuous flow of salt solutions in each chamber of the electrochemical cell.

In some embodiments, the electrochemical cell has differential rates of flow of salt solutions in each chamber of the electrochemical cell.

In some embodiments, multiple electrochemical cells are arrayed parallel to each other and electrically connected to form an electrochemical stack.

In certain embodiments, the electrochemical cell further comprises a reference electrode. The reference electrode allows for measurement of the potential of each half-reaction, indicating how much electrical energy is required for the reaction to proceed.

In certain embodiments, the anode is contacted with hydrogen gas and carries out the oxidation of hydrogen gas to protons and electrons.

In certain embodiments, the anode oxidizes water to produce oxygen, protons, and electrons.

In certain embodiments, the cathode reduces water to produce hydrogen gas, hydroxide ions and electrons.

In certain embodiments, a voltage of >0.7 V is applied between the anode and the cathode.

In certain embodiments, an electrical current corresponding to a current density of >100 mA/cm² is applied between the anode and the cathode.

In certain embodiments, the electrical current is taken from renewable sources including, but not limited to, solar, wind, and hydroelectric power.

In certain embodiments, the cathode can display a potential between 0.0 and 1.0 V negative of a reversible hydrogen electrode positioned in the cathode chamber.

In certain embodiments, the anode can display a potential between 0.0 and 1.0 V negative of a reversible hydrogen electrode positioned in the cathode chamber.

In some embodiments, the electrochemical cell has a Faradaic efficiency for electrohydrolysis of greater than or equal to about 30%.

In certain embodiments, the electrochemical step is conducted at a temperature less than or equal to 100° C.

### Cathode/Anode

In certain embodiments, exemplary cathode catalyst materials include, but are not limited to, platinum, palladium, gold, nickel, nickel alloys, nitrogen-doped carbon, silver, iridium, rhodium, cobalt, and steel.

In a preferred embodiment, the anode comprises platinum, such as platinum nanoparticles supported on carbon.

In certain embodiments, exemplary anode catalysts include, but are not limited to, platinum, palladium, gold, nickel, nickel alloys, nitrogen-doped carbon, silver, iridium, ruthenium, iridium oxide, ruthenium oxide, rhodium, cobalt, and steel.

### Separators

In certain embodiments, the separators are membranes that are selectively permeable to cations relative to anions.

In certain embodiments, the separators are membranes that are selectively permeable to anions relative to cations.

In certain embodiments, the separators are diaphragms that are permeable to both anions and cations.

In certain embodiments, the separators are bipolar membranes consisting of anion and cation permeable components in contact with each other.

In certain embodiments, multiple separators are positioned parallel to each other in the electrochemical cell.

### Salt Solution

In certain embodiments, the salt solution includes, but is not limited to, cations of sodium, potassium, lithium, magnesium, calcium, iron.

In certain embodiments, the salt solution includes, but is not limited to, hydroxide, oxide, carbonate, silicate, chloride, phosphate, phosphate, and/or sulfate anions.

In certain embodiments, salt solution flowed into the electrochemical cell has a pH from 7 to 14.

In certain embodiments, a salt solution with a pH from 0 to 7 is flowed through the electrochemical cell to regenerate the function of the anode, cathode, and/or membrane.

In certain embodiments, the salt solution flowing out of one chamber of the electrochemical cell has a pH from 0 to 4.

In certain embodiments, the salt solution flowing out of a second chamber of the electrochemical cell has a pH from 8 to 14.

In certain embodiments, the salt solution flowing out of a chamber is repeatedly recirculated through the same chamber of the electrochemical cell to increase its pH.

In certain embodiments, the salt solution flowing out of a chamber is repeatedly recirculated through the same chamber of the electrochemical cell to lower its pH.

In certain embodiments, the salt solution is contacted with CO₂ prior to flowing into the electrochemical cell.

In certain embodiments, bicarbonate or carbonate salts are added to the salt solution prior to flowing into the electrochemical cell.

### Silicate-Containing Material

In some embodiments, the silicate-containing material comprises at least 10 wt % MgO.

In some embodiments, the silicate-containing material comprises at least 10 wt % CaO.

In some embodiments, the silicate-containing material comprises MgO and CaO in a total of at least 10 wt %.

In some embodiments, the silicate-containing material comprises a mafic or ultramafic rock.

In some embodiments, the silicate-containing material comprises peridotite.

In some embodiments, the silicate-containing material comprises a basaltic rock.

In some embodiments, the silicate-containing material comprises dunite.

In some embodiments, the silicate-containing material comprises olivine.

In some embodiments, the silicate-containing material comprises forsterite.

In some embodiments, the silicate-containing material comprises serpentinite.

In some embodiments, the silicate-containing material comprises serpentine.

In some embodiments, the silicate-containing material comprises pyroxene.

In some embodiments, the silicate-containing material is a material obtained as a byproduct or waste product of mining.

In some embodiments, the silicate-containing material is a mine tailing.

In some embodiments, the silicate-containing material is crushed or ground to particle sizes less than 10 μm.

In some embodiments, the silicate-containing material is crushed or ground to particle sizes less than 100 μm.

In some embodiments, the silicate-containing material is crushed or ground to particle sizes less than 200 μm.

In some embodiments, the silicate-containing material is crushed or ground to particle sizes less than 500 μm.

In some embodiments, the silicate-containing material is crushed or ground to particle sizes less than 1000 μm.

In some embodiments, the silicate-containing material is crushed or ground to particle sizes less than 5000 μm.

### Product Material

In some embodiments, the product material is a substantially amorphous material.

In some embodiments, the product material is a mixture of amorphous and crystalline phases.

In some embodiments, the product material comprises hydroxide ions (OH⁻).

In some embodiments, the product material comprises Mg(OH)₂.

In some embodiments, the product material comprises MgO.

In some embodiments, the product material comprises Ca(OH)₂.

In some embodiments, the product material comprises CaO.

In some embodiments, the product material comprises a hydrated magnesium silicate.

In some embodiments, the product material comprises a hydrated calcium silicate.

In some embodiments, the product material comprises minor amounts of one or more ions from the salt solution.

In some embodiments, the product material comprises a Mg:Si ratio greater than 1:1.

In some embodiments, the product material comprises a Ca:Si ratio greater than 1:1.

In some embodiments, the product material, when suspended in H₂O at ambient temperature and placed under 1 atm of CO₂, reacts to form a magnesium carbonate in >10% yield in 3 h, where 100% yield corresponds to 1 CO₃²⁻ ion for every Mg²⁺ ion or 2 HCO₃⁻ ions for every Mg²⁺ ion.

In some embodiments, the product material, when suspended in H₂O at ambient temperature and placed under 1 atm of CO₂, reacts to form a magnesium carbonate in >30% yield in 3 h, where 100% yield corresponds to 1 CO₃²⁻ ion or 2 HCO₃⁻ ions for every Mg²⁺ ion.

In some embodiments, the product material, when suspended in H₂O at ambient temperature and placed under 1 atm of CO₂, reacts to form a magnesium carbonate in >50% yield in 3 h, where 100% yield corresponds to 1 CO₃²⁻ ion or 2 HCO₃⁻ ions for every Mg²⁺ ion.

In some embodiments, the product material, when suspended in H₂O at ambient temperature and placed under 1 atm of CO₂, reacts to form a magnesium carbonate in >70% yield in 3 h, where 100% yield corresponds to 1 CO₃²⁻ ion or 2 HCO₃⁻ ions for every Mg²⁺ ion.

In some embodiments, the product material, when suspended in H₂O at ambient temperature and placed under 1 atm of CO₂, reacts to form a calcium carbonate in >10% yield in 3 h, where 100% yield corresponds to 1 CO₃²⁻ ion or 2 HCO₃⁻ ions for every Ca²⁺ ion.

In some embodiments, the product material, when suspended in H₂O at ambient temperature and placed under 1 atm of CO₂, reacts to form a calcium carbonate in >30% yield in 3 h, where 100% yield corresponds to 1 CO₃²⁻ ion or 2 HCO₃⁻ ions for every Ca²⁺ ion.

In some embodiments, the product material, when suspended in H₂O at ambient temperature and placed under 1 atm of CO₂, reacts to form a calcium carbonate in >50% yield in 3 h, where 100% yield corresponds to 1 CO₃²⁻ ion or 2 HCO₃⁻ ions for every Ca²⁺ ion.

In some embodiments, the product material, when suspended in H₂O at ambient temperature and placed under 1 atm of CO₂, reacts to form a calcium carbonate in >70% yield in 3 h, where 100% yield corresponds to 1 CO₃²⁻ ion or 2 HCO₃⁻ ions for every Ca²⁺ ion.

The following Detailed Description references the accompanying drawings which form a part this application, and which show, by way of illustration, specific example implementations. Other implementations may be made without departing from the scope of the disclosure.

### BRIEF DESCRIPTION OF THE DRAWINGS

FIG. 1 shows a schematic depiction of a system for transforming a magnesium silicate-containing material into a CDR material and a byproduct.

FIG. 2 shows the cell voltage vs time trace for an electrochemical cell used to generate acidic and basic solutions from a salt solution.

FIG. 3A shows SEM and EDS analysis of the solid byproduct obtained from processing olivine with the acidic and basic solutions derived from an electrochemical cell.

FIG. 3B shows the pXRD of CDR material obtained from processing olivine with the acidic and basic solutions derived from an electrochemical cell.

FIG. 3C shows the SEM and EDS of CDR material obtained from processing olivine with the acidic and basic solutions derived from an electrochemical cell.

FIG. 4A shows the pXRD of CDR material obtained from olivine before and after carbonation with 1 atm CO₂ at ambient temperature and pressure.

FIG. 4B shows the TGA of CDR material obtained from olivine after carbonation with 1 atm CO₂ at ambient temperature and pressure.

FIG. 5A shows the pXRD of CDR material obtained from processing serpentine with alternating acidic and basic solutions derived from an electrochemical cell.

FIG. 5B shows the SEM and EDS analysis of CDR material obtained from processing serpentine with the acidic and basic solutions derived from an electrochemical cell.

FIG. 5C shows the TGA of CDR material obtained from processing serpentine with acidic and basic solutions derived from an electrochemical cell.

FIG. 6 shows the conversion of CDR material to carbonate under 1 atm CO₂ at ambient temperature.

FIG. 7 shows the natural carbonation of CDR material under atmospheric CO₂ at ambient temperature.

FIG. 8 shows the rate of CO₂ uptake into the CDR material at ambient temperature

### DETAILED DESCRIPTION

Disclosed are a system and a method for transforming a silicate-containing material into a product material or product materials using acidic and basic solutions generated from an electrochemical system operating on a salt solution. In some embodiments, a product material is a material that reacts with CO₂-containing gases orders of magnitude faster than the original silicate-containing material to form a carbonate-containing material. Such a product material is referred to as a CDR material. In some embodiments, the product material is used to remove CO₂ from the air or from a natural or man-made CO₂ emission source wherein the CO₂ is sequestered in the carbonate-containing material.

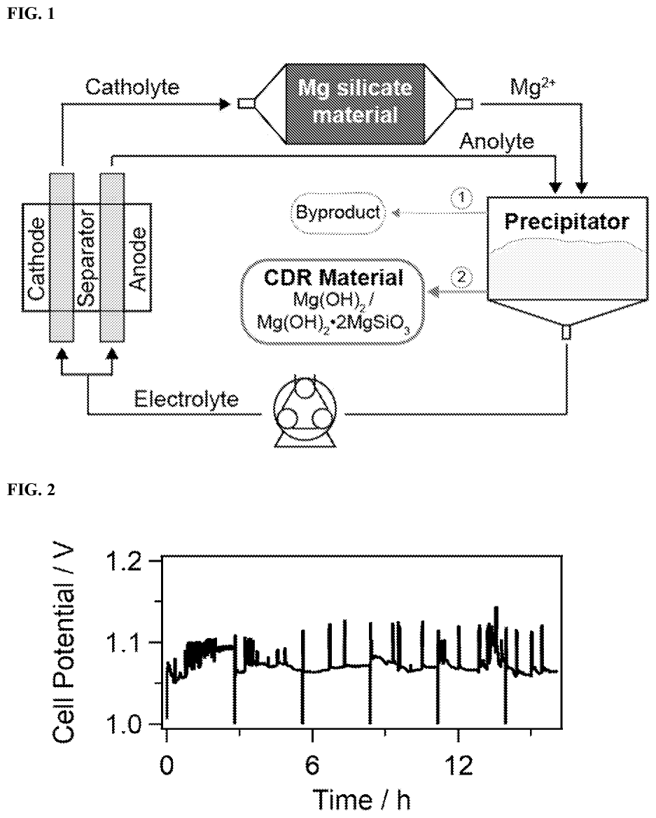

The system comprises an electrochemical system, a salt solution, an apparatus or vessel for contacting a solution with a silicate-containing material, a power source, and pumps for moving fluids through the system. In some embodiments, the system further comprises an apparatus or vessel for forming a precipitate in a solution and separating the precipitate from a solution (FIG. 1). In some embodiments, the system operates in a closed loop wherein the transformation of the silicate-containing material into the product material is performed with the consumption of electric power and H₂O and the salt solution is recycled.

The method comprises a number of steps that can be performed sequentially, or continuously, or semi-continuously. The method comprises using the electrochemical system to convert a salt solution into an acidic solution and a basic solution and using the acidic and basic solutions to transform the silicate-containing material into a product material or product materials.

In some embodiments, the electrochemical system comprises one or more electrochemical cells, each of which comprises a cathode, an anode, a catholyte, an anolyte, and a separator to separate the catholyte from the anolyte. The catholyte and the anolyte are obtained from the salt solution. During operation of the cell, the catholyte and the anolyte are flowed through the cathode and anode compartments, respectively, and electrochemical reactions increase the pH of the catholyte and decrease the pH of the anolyte. The energy demand of the electrochemical system can be minimized by choosing cathodic and anodic reactions such that the product of the cathodic reaction is the reactant for the anodic reaction. In some embodiments, the cathode performs water reduction to produce H₂ and OH⁻ and the anode performs H₂ oxidation to produce H⁺. The OH⁻ increases the pH of the catholyte and the H⁺ decreases the pH of the anolyte. In some embodiments, H₂ produced at the cathode of the electrochemical cell is transported passively or actively to the anode. In some embodiments wherein multiple cells are arranged in parallel in a stack, the H₂ produced at the cathode of one cell is transported passively or actively to the anode of an adjacent cell. In other embodiments, redox mediators are used for the cathodic and anodic reactions such that the reduced mediator generated at the cathode is oxidized at the anode of the same electrochemical cell or of an adjoining electrochemical cell. In some embodiments, the catholyte is separated from the anolyte by a porous separator or diaphragm. In other embodiments, the catholyte is separated from the anolyte by an ion exchange membrane. In some embodiments, the ion exchange membrane is a cation exchange membrane. In some embodiments, the ion exchange membrane is an anion exchange membrane. In some embodiments, electrochemical cells are arrayed parallel to each other and electrically connected to form an electrochemical stack.

In other embodiments, a series of sets of membranes, each comprising a cation exchange membrane, a bipolar membrane, and an anion exchange membrane, are arrayed parallel to each other and ionically connected and combined with an anode and a cathode to form a bipolar membrane electrodialysis cell. The transformation of the silicate-containing material into the CDR material and byproduct and/or residual materials comprises a number of steps. In some embodiments, the silicate-containing material is treated first with the acidic solution, which causes dissolution to form a leachate solution that contains Mg²⁺ and/or Ca²⁺ cations. In some embodiments, the leachate solution also contains silicic acid (Si(OH)₄) and other cations that were part of the original silicate-containing material. This process neutralizes some or all the acid originally present in the acidic solution. The leachate solution is then combined with the basic solution generated by the electrochemical cell. In some embodiments, combining with the basic solution is performed stepwise, wherein a first portion of the basic solution is combined with the leachate solution to form a precipitate that contains predominantly SiO₂ and/or metal ions other than Mg²⁺ or Ca²⁺. In some embodiments, the metal ions other than Mg²⁺ or Ca²⁺ are Fe²⁺, Fe³⁺, and/or Ni²⁺ and the precipitate contains these ions in the form of hydroxides, oxides, or silicate (e.g. Fe(OH)₂, Ni(OH)₂, Fe₂O₃, FeSiO₃). This precipitate formed by combination of the leachate solution with the first portion of basic solution is separated from the leachate solution and a second portion of basic solution is combined with the leachate solution to form a precipitate comprising a CDR material. The CDR material contains some or all the elements present in the original silicate-containing material but exhibits greatly accelerated reactivity with CO₂-containing gases. In some embodiments, the CDR material comprises predominantly Mg(OH)₂. In other embodiments, the CDR material comprises predominantly Ca(OH)₂. In other embodiments, the CDR material comprises predominantly MgSiO₃. In other embodiments, the CDR material comprises predominantly CaSiO₃. In some embodiments, the CDR material comprises Mg(OH)₂, Ca(OH)₂, MgSiO₃, and/or CaSiO₃. In some embodiments, the CDR material comprises SiO₂ in addition to Mg²⁺ and/or Ca²⁺ containing solids. In some embodiments, the CDR material is not a combination of pure hydroxide, silicate, and SiO₂ phases but rather a mixed-phase, heterogeneous, and typically substantially amorphous material. The precipitation of the CDR material from the leachate solution regenerates a salt solution that is separated from the CDR material and recycled to the electrochemical step.

In other embodiments, the silicate-containing material is treated first with the acidic solution generated by the electrochemical cell, which causes dissolution to form a leachate solution containing Mg²⁺ and/or Ca²⁺ cations, and the leachate solution is combined with the basic solution generated by the electrochemical cell in one step to form a precipitate comprising the CDR material. The CDR material contains some or all the elements present in the original silicate-containing material but exhibits greatly accelerated reactivity with CO₂-containing gases. In some embodiments, the CDR material comprises predominantly Mg(OH)₂. In other embodiments, the CDR material comprises predominantly Ca(OH)₂. In other embodiments, the CDR material comprises predominantly MgSiO₃. In other embodiments, the CDR material comprises predominantly CaSiO₃. In some embodiments, the CDR material comprises Mg(OH)₂, Ca(OH)₂, MgSiO₃, and/or CaSiO₃. In some embodiments, the CDR material comprises SiO₂ in addition to Mg²⁺ and/or Ca²⁺ containing solids. In some embodiments, the CDR material is not a combination of pure hydroxide, silicate, and SiO₂ phases but rather a mixed-phase, heterogeneous, and typically substantially amorphous material. The precipitation of the CDR material from the leachate solution regenerates a salt solution that is separated from the CDR material and recycled to the electrochemical step.

In other embodiments, the silicate-containing material is treated with the acidic solution to form an acidic leachate and then the silicate-containing material is treated with the basic solution to form a basic leachate. Treatment of the silicate-containing material with the acidic solution to form an acidic leachate followed by the basic solution to form a basic leachate can be repeated many times to remove most or all the Mg²⁺ and/or Ca²⁺ cations from the silicate-containing material. The acidic leachate and the basic leachate are then combined to precipitate the CDR material. The CDR material contains some or all the elements present in the original silicate-containing material but exhibits greatly accelerated reactivity with CO₂-containing gases. In some embodiments, the CDR material comprises predominantly Mg(OH)₂. In other embodiments, the CDR material comprises predominantly Ca(OH)₂. In other embodiments, the CDR material comprises predominantly MgSiO₃. In other embodiments, the CDR material comprises predominantly CaSiO₃. In some embodiments, the CDR material comprises Mg(OH)₂, Ca(OH)₂, MgSiO₃, and/or CaSiO₃. In some embodiments, the CDR material comprises SiO₂ in addition to Mg²⁺ and/or Ca²⁺ containing solids. In some embodiments, the CDR material is not a combination of pure hydroxide, silicate, and SiO₂ phases but rather a mixed-phase, heterogeneous, and typically substantially amorphous material. The precipitation of the CDR material by combining the acidic leachate and the basic leachate solutions regenerates a salt solution that is separated from the CDR material and recycled to the electrochemical step.

The preferred embodiment for the procedure used to transform the silicate-containing material into a CDR material with the acidic and basic solutions generated by the electrochemical system may vary depending on the mineral composition of the silicate-containing material. For silicate-containing materials comprising predominantly orthosilicates (e.g., forsterite with formula Mg₂SiO₄), treatment with a stoichiometric or excess amount of acidic solution (where “stoichiometric” means two equivalents of H⁺ per Mg²⁺ cation) can dissolve most or substantially all the Mg²⁺ ions. The preferred embodiment in this case is to treat the silicate-containing material with the acidic solution to form the acidic leachate solution and combine the acidic leachate solution with the basic solution to form the CDR material in one or more steps. For silicate-containing materials comprising predominantly phyllosilicate minerals (e.g. serpentine minerals: chrysotile, antigorite, lizardite with formula Mg₃Si₂O₅(OH)₄), treatment of the silicate-containing material with stoichiometric or excess acidic solution (where “stoichiometric” means two equivalents of H⁺ per Mg²⁺ cation) can rapidly dissolve only a portion of the Mg²⁺ cations because dissolution of the Mg²⁺ cations results in formation of a passivating silica (SiO₂) layer on the remaining silicate material. The preferred embodiment in this case is to treat the silicate-containing material with alternating acidic and basic solutions to form acidic leachate solution and basic leachate solution and combine the acidic leachate and basic leachate solutions in one or more steps to precipitate the CDR material. The passivating silica layers formed by treatment with the acidic solution are removed by treatment with the basic solution to enable dissolution of more Mg²⁺ cations upon treatment with the subsequent acidic solution.

In addition to the electrochemical system, other ancillary energy inputs are needed for sourcing, transporting, and crushing silicate materials, pumping liquids, and deploying the CDR material to contact it with air or any CO₂-containing gas. These ancillary energy inputs are generally small compared to the energy required for the electrochemical system.

Because the CDR material reacts much more rapidly than the original silicate, it can be deployed to remove CO₂ in a wide range of applications. Examples include contacting the material with air itself, air that has been enriched in CO₂ from a capture process, an emissions source from an industrial process, or any other CO₂-containing gas. After the material has taken up CO₂ to form (bi) carbonates, it can be stored in a pit, buried, or, if the original silicate was extracted from a mine, returned to the extraction site. Alternatively, the reactive material could be dispersed in the ocean to increase the alkalinity of the ocean. Since the ocean is in equilibrium with the atmosphere, adding alkalinity results in the uptake of CO₂ into the ocean in the form of bicarbonate, which has a lifetime of >100,000 years. Enhancing ocean alkalinity has additional potential benefits of reversing ocean acidification, which threatens ecosystems such as coral reefs that depend on biogenic calcification. As another example, the material can be added to a landfill to sequester CO₂ generated by the decomposition of organic matter in the landfill. This application could have the additional benefit of reducing CH₄ emissions from a landfill because CH₄ in landfill gas is generated from CO₂ and H₂.

### Methods of the Invention

One aspect of the present invention provides a method of forming a precipitate, comprising:
a. providing a salt solution;
b. performing electrochemical reactions in the salt solution to produce a solution of lower pH and a solution of higher pH;
c. providing a silicate-containing material containing Mg²⁺ and/or Ca²⁺ ions;
d. treating the silicate-containing material with the solution of lower pH to dissolve at least a portion of the silicate-containing material to generate a second solution with higher pH;
e. combining the solution generated in (d) with at least a portion of the solution with higher pH generated in (b) to form the precipitate and a second salt solution; and
f. recycling the salt solution formed in step (e) by adding the salt solution to (b).

In some embodiments, (f) is optional.

In some embodiments, wherein the silicate-containing material comprises less than 30% Si by mass.

In some embodiments, wherein the silicate-containing material comprises a ratio of O to Si greater than or equal to 3:1.

In some embodiments, the precipitate comprises XₐY_{b}Z_{c}, wherein X and Y are selected from the group consisting of Na, K, Li, Ca, Mg, Fe, Al, and Si; Z is selected from the group consisting of O, OH, Cl, Br, I, F, S, N, SO₄, and ClO₄; and a, b, and c each range from 0.001 to 99.999.

In some embodiments, the salt solution comprises alkali cations and chloride anions.

In some embodiments, the salt solution comprises alkali cations and sulfate anions.

In some embodiments, additional salts are added to the salt solution.

In some embodiments, (b) comprises performing electrohydrolysis

In some embodiments, (b) comprises bipolar membrane electrodialysis.

In some embodiments, a cell comprising a cathode, an anode, and a separator is used in (b).

In some embodiments, a cell stack comprising repeating units of a cathode, a separator, and an anode is used in (b), and the units are electrically connected in series.

In some embodiments, a cell comprising a cathode, a separator, an anode, and a number of repeating units in between the separator and anode consisting of a bipolar membrane and a separator is used in (b).

In some embodiments, the cathode produces hydrogen gas and the anode consumes hydrogen gas.

In some embodiments, the cathode comprises Pt, Pd, Ni, Ir, Rh, Co, Ru, Fe, Mn, Ti, Zr, Au, Ag, Cu, Pb, Bi, and/or carbon.

In some embodiments, the anode comprises Pt, Pd, Ni, Ir, Iridium Oxide, Rh, Co, Ru, Ruthenium Oxide, Fe, Mn, Ti, Zr, Au, Ag, Cu, Pb, Bi, and/or carbon.

In some embodiments, the separator comprises an ion exchange membrane or diaphragm.

In some embodiments, an electrical current from 10 to 2000 mA/cm² is applied.

In some embodiments, the salt solution is flowed at a rate of 0.1 to 100 mL/min/cm² through the cathode and anode compartments.

In some embodiments, the salt solution is pH 0-14. In other embodiments, the salt solution is pH 7-14.

In some embodiments, the solution of lower pH range is pH 0-7.

In some embodiments, the solution of higher pH range is pH 7-14.

In some embodiments, the solution of lower pH is stored and/or recirculated to the electrochemical cell prior to exposure to the silicate-containing material.

In some embodiments, the solution of higher pH is stored and/or recirculated to the electrochemical cell prior to exposure to the solution generated in (d).

In some embodiments, the solution generated in (d) is separated from remaining silicate-containing material before (e).

In some embodiments, the solution generated in (d) is not separated from remaining silicate-containing material before (e).

In some embodiments, carbonate salt is added to the salt solution to precipitate cations.

In some embodiments, the salt solution is contacted with CO₂ prior to recirculation to (b).

In some embodiments, the precipitate generated in (e) comprises a substantially amorphous material, a crystalline material, or a mixture thereof.

In some embodiments, the precipitate generated in (e) is added to agricultural soils. In other embodiments, the precipitate generated in (e) is added to body of water. In other embodiments, the precipitate generated in (e) is added to land-fill. In other embodiments, the precipitate generated in (e) is distributed over land. In other embodiments, the precipitate generated in (e) is added to a cement.

Another aspect of the present invention provides a method for sequestering carbon dioxide comprising:
a. providing a salt solution;
b. performing electrochemical reactions in the salt solution to produce a solution of lower pH and a solution of higher pH;
c. providing a silicate-containing material containing Mg²⁺ and/or Ca²⁺ ions;
d. treating the silicate-containing material with the solution of lower pH to dissolve at least a portion of the silicate-containing material and generate a second solution with higher pH;
e. combining the solution generated in (d) with at least a portion of the solution with higher pH generated in (b) to form a precipitate and a second salt solution;
f. recycling the salt solution formed in (e) by adding the salt solution to (b); and
g. exposing the precipitate formed in (e) to a CO₂-containing gas.

In some embodiments, (f) is optional.

In some embodiments, the silicate-containing material comprises less than 30% Si by mass.

In some embodiments, the silicate-containing material comprises a ratio of O to Si greater than or equal to 3:1.

In some embodiments, the precipitate comprises XₐY_{b}Z_{c} wherein X and Y are selected from the group consisting of Na, K, Li, Ca, Mg, Fe, Al, and Si; Z is selected from the group consisting of O, OH, Cl, Br, I, F, S, N, SO₄, and ClO₄; and a, b, and c each range from 0.001 to 99.999.

In some embodiments, the salt solution comprises alkali cations and chloride anions.

In some embodiments, the salt solution comprises alkali cations and sulfate anions.

In some embodiments, additional salts are added to the salt solution.

In some embodiments, (b) comprises performing electrohydrolysis.

In some embodiments, (b) comprises bipolar membrane electrodialysis

In some embodiments, a cell comprising a cathode, an anode, and a separator is used in (b).

In some embodiments, a cell stack comprising repeating units of a cathode, a separator, and an anode is used in (b), and the units are electrically connected in series.

In some embodiments, a cell comprising a cathode, a separator, an anode, and a number of repeating units in between the separator and anode consisting of a bipolar membrane and a separator is used in (b).

In some embodiments, the cathode produces hydrogen gas and the anode consumes hydrogen gas.

In some embodiments, cathode comprises Pt, Pd, Ni, Ir, Rh, Co, Ru, Fe, Mn, Ti, Zr, Au, Ag, Cu, Pb, Bi, and/or carbon.

In some embodiments, the anode comprises Pt, Pd, Ni, Ir, Iridium Oxide, Rh, Co, Ru, Ruthenium Oxide, Fe, Mn, Ti, Zr, Au, Ag, Cu, Pb, Bi, and/or carbon.

In some embodiments, the separator comprises an ion exchange membrane or a diaphragm.

In some embodiments, an electrical current from 10 to 2000 mA/cm² is applied.

In some embodiments, the salt solution is flowed at a rate of 0.1 to 100 mL/min/cm² through the cathode and anode compartments.

In some embodiments, the salt solution is pH 0-14. In other embodiments, the salt solution is pH 7-14.

In some embodiments, the solution of lower pH is pH 0-7.

In some embodiments, the solution of higher pH range is pH 7-14.

In some embodiments, the solution of lower pH is stored and/or recirculated to the electrochemical cell prior to exposure to the silicate-containing material.

In some embodiments, the solution of higher pH is stored and/or recirculated to the electrochemical cell prior to exposure to the solution generated in (d).

In some embodiments, the solution generated in (d) is separated from remaining silicate-containing material before (e).

In some embodiments, the solution generated in (d) is not separated from remaining silicate-containing material before (e).

In some embodiments, carbonate salt is added to salt solution to the precipitate cations.

In some embodiments, the salt solution is contacted with CO₂ prior to recirculation to (b).

In some embodiments, the precipitate generated in (e) is a substantially amorphous material, a crystalline material, or a mixture thereof.

In some embodiments, the precipitate generated in (e) is added to agricultural soils. In other embodiments, the precipitate generated in (e) is added to body of water. In other embodiments, the precipitate generated in (e) is added to land-fill. In other embodiments, the precipitate generated in (e) is distributed over land. In some embodiments, the precipitate generated in (e) is added to a cement.

In some embodiments, the CO₂-containing gas in (g) is air.

In some embodiments, the CO₂-containing gas in (g) comprises at least 1% CO₂.

In some embodiments, the precipitate generated in (e) reacts with 1 atm of CO₂ in H₂O at <30° C. to form a magnesium carbonate or magnesium bicarbonate in >10% yield in less than 1 h.

Another aspect of the present invention provides a method of forming a precipitate comprising:
a. providing a salt solution;
b. performing electrochemical reactions in the salt solution to produce a solution of lower pH and a solution of higher pH;
c. providing a silicate-containing material containing Mg²⁺ and/or Ca²⁺ ions;
d. treating the silicate-containing material with the solution of lower pH to dissolve at least a portion of the silicate-containing material and generate a second solution with higher pH;
e. treating the treated silicate-contain material generated in (d) with the solution of higher pH to dissolve at least a portion of the silicate-containing material and generate a second solution with lower pH;
f. combining the solution generated in (d) with at least a portion of the solution generated in (e) to form the precipitate and a second salt solution; and
g. recycling the salt solution formed in (f) by adding the salt solution to (b).

In some embodiments, (g) is optional.

In some embodiments, the silicate-containing material comprises less than 30% Si by mass.

In some embodiments, the silicate-containing material comprises a ratio of O to Si greater than or equal to 3:1.

In some embodiments, the precipitate comprises XₐY_{b}Z_{c}, wherein X and Y are selected from the group consisting of Na, K, Li, Ca, Mg, Fe, and Al, Si; Z is selected from the group consisting of O, OH, Cl, Br, I, F, S, N, SO₄, and ClO₄; and a, b, and c each range from 0.001 to 99.999.

In some embodiments, the salt solution comprises alkali cations and chloride anions.

In some embodiments, the salt solution comprises alkali cations and sulfate anions.

In some embodiments, additional salts are added to the salt solution.

In some embodiments, (b) comprises performing electrohydrolysis

In some embodiments, (b) comprises bipolar membrane electrodialysis.

In some embodiments, a cell comprising a cathode, an anode, and a separator is used in (b).

In some embodiments, a cell stack comprising repeating units of a cathode, a separator, and an anode is used in (b), and the units are electrically connected in series.

In some embodiments, a cell comprising a cathode, a separator, an anode, and a number of repeating units in between the separator and anode consisting of a bipolar membrane and a separator is used in (b).

In some embodiments, the cathode produces hydrogen gas and the anode consumes hydrogen gas.

In some embodiments, the cathode comprises Pt, Pd, Ni, Ir, Rh, Co, Ru, Fe, Mn, Ti, Zr, Au, Ag, Cu, Pb, Bi, and/or carbon.

In some embodiments, the anode comprises Pt, Pd, Ni, Ir, Iridium Oxide, Rh, Co, Ru, Ruthenium Oxide, Fe, Mn, Ti, Zr, Au, Ag, Cu, Pb, Bi, and/or carbon.

In some embodiments, the separator comprises an ion exchange membrane or diaphragm.

In some embodiments, an electrical current from 10 to 2000 mA/cm² is applied.

In some embodiments, the salt solution is flowed at a rate of 0.1 to 100 mL/min/cm² through the cathode and anode compartments.

In some embodiments, the salt solution is pH 0-14.

In other embodiments, the salt solution is pH 7-14.

In some embodiments, the solution of lower pH range is pH 0-7.

In some embodiments, the solution of higher pH range is pH 7-14.

In some embodiments, the solution of lower pH is stored and/or recirculated to the electrochemical cell prior to exposure to the silicate-containing material.

In some embodiments, the solution of higher pH is stored and/or recirculated to the electrochemical cell prior to exposure to the silicate-containing material generated in (d).

In some embodiments, the solution generated in (d) is separated from remaining silicate-containing material before (f) and/or the solution generated in (e) is separated from remaining silicate-containing material before (f).

In some embodiments, the solution generated in (d) is not separated from remaining silicate-containing material before (f) and/or the solution generated in (e) is not separated from remaining silicate-containing material before (f).

In some embodiments, carbonate salt is added to the salt solution to precipitate cations.

In some embodiments, the second salt solution is contacted with CO₂ prior to recirculation to (b).

In some embodiments, the precipitate generated in (f) comprises a substantially amorphous material, a crystalline material, or a mixture thereof.

In some embodiments, the precipitate generated in (f) is added to agricultural soils. In other embodiments, the precipitate generated in (f) is added to body of water. In other embodiments, the precipitate generated in (f) is added to land-fill. In other embodiments, the precipitate generated in (f) is distributed over land. In other embodiments, the precipitate generated in (f) is added to a cement.

Another aspect of the present invention provides a method for sequestering carbon dioxide comprising:
a. providing a salt solution;
b. performing electrochemical reactions in the salt solution to produce a solution of lower pH and a solution of higher pH;
c. providing a silicate-containing material containing Mg²⁺ and/or Ca²⁺ ions
d. treating the silicate-containing material with the solution of lower pH to dissolve at least a portion of the silicate-containing material and generate a second solution with higher pH;
e. treating the treated silicate-contain material generated in (d) with the solution of higher pH to dissolve at least a portion of the silicate-containing material and generate a second solution with lower pH;
f. combining the solution generated in (d) with at least a portion of the solution generated in (e) to form a precipitate and a second salt solution;
g. recycling the salt solution formed in (f) by adding the salt solution to (b); and
h. exposing the precipitate formed in (f) to a CO₂-containing gas.

In some embodiments, (g) is optional.

In some embodiments, the silicate-containing material comprises less than 30% Si by mass.

In some embodiments, the silicate-containing material comprises a ratio of O to Si greater than or equal to 3:1.

In some embodiments, the precipitate comprises XₐY_{b}Z_{c} wherein X and Y are selected from the group consisting of Na, K, Li, Ca, Mg, Fe, Al, and Si; Z is selected from the group consisting of O, OH, Cl, Br, I, F, S, N, SO₄, and ClO₄; and a, b, and c each range from 0.001 to 99.999.

In some embodiments, the salt solution comprises alkali cations and chloride anions.

In some embodiments, the salt solution comprises alkali cations and sulfate anions.

In some embodiments, additional salts are added to the salt solution.

In some embodiments, (b) comprises performing electrohydrolysis.

In some embodiments, (b) comprises bipolar membrane electrodialysis

In some embodiments, a cell comprising a cathode, an anode, and a separator is used in (b)

In some embodiments, a cell stack comprising repeating units of a cathode, a separator, and an anode is used in (b), and the units are electrically connected in series.

In some embodiments, a cell comprising a cathode, a separator, an anode, and a number of repeating units in between the separator and anode consisting of a bipolar membrane and a separator is used in (b).

In some embodiments, the cathode produces hydrogen gas and the anode consumes hydrogen gas.

In some embodiments, the cathode comprises Pt, Pd, Ni, Ir, Rh, Co, Ru, Fe, Mn, Ti, Zr, Au, Ag, Cu, Pb, Bi, and/or carbon.

In some embodiments, the anode comprises Pt, Pd, Ni, Ir, Iridium Oxide, Rh, Co, Ru, Ruthenium Oxide, Fe, Mn, Ti, Zr, Au, Ag, Cu, Pb, Bi, and/or carbon.

In some embodiments, the separator comprises an ion exchange membrane or a diaphragm.

The method of any one of claims 115-121, wherein an electrical current between 10 and 2000 mA/cm² is applied.

In some embodiments, salt solution is flowed at a rate of 0.1 to 100 mL/min/cm² through the cathode and anode compartments.

In some embodiments, the salt solution is pH 0-14. In other embodiments, the salt solution is pH 7-14.

In some embodiments, the solution of lower pH is pH 0-7.

In some embodiments, the solution of higher pH range is pH 7-14.

In some embodiments, the solution of lower pH is stored and/or recirculated to the electrochemical cell prior to exposure to the silicate-containing material.

In some embodiments, the solution of higher pH is stored and/or recirculated to the electrochemical cell prior to exposure to the solution generated in (d).

In some embodiments, the solution generated in (d) is separated from remaining silicate-containing material before (f) and/or the solution generated in (e) is separated from remaining silicate-containing material before (f).

In some embodiments, the solution generated in (d) is not separated from remaining silicate-containing material before (f) and/or the solution generated in (e) is not separated from remaining silicate-containing material before (f).

In some embodiments, carbonate salt is added to the salt solution to precipitate cations.

In some embodiments, the second salt solution is contacted with CO₂ prior to recirculation to (b).

In some embodiments, the precipitate generated in (f) is a substantially amorphous material, a crystalline material, or a mixture thereof.

In some embodiments, the precipitate generated in (f) is added to agricultural soils. In other embodiments, the precipitate generated in (f) is added to body of water. In other embodiments, the precipitate generated in (f) is added to land-fill. In other embodiments, the precipitate generated in (f) is distributed over land. In other embodiments, the precipitate generated in f) is added to a cement.

In some embodiments, the CO₂-containing gas in (g) is air.

In some embodiments, the CO₂-containing gas in (g) comprises at least 1% CO₂.

In some embodiments, the precipitate generated in (e) reacts with 1 atm of CO₂ in H₂O at <30° C. to form a magnesium carbonate or magnesium bicarbonate in >10% yield in less than 1 h.

Another aspect of the present invention provides a method for extracting a transition metal ion-containing precipitate comprising:
a. providing a salt solution;
b. performing electrochemical reactions in the salt solution to produce a solution of lower pH and a solution of higher pH;
c. providing a silicate-containing material containing transition metal ions, e.g. silicate-containing Ni laterites;
d. treating the silicate-containing material with the solution of lower pH to dissolve at least a portion of the silicate-containing material to generate a solution with higher pH;
e. combining the solution generated in (d) with at least a portion of the solution with higher pH generated in (b) to form the transition metal ion-containing precipitate and a second salt solution; and
f. recycling the salt solution formed in step (e) by adding the salt solution to (b).

In some embodiments, (f) is optional.

In some embodiments the silicate-containing material comprises less than 30% Si by mass.

In some embodiments the silicate-containing material comprises a ratio of O to Si greater than or equal to 3:1.

In some embodiments the precipitate comprises XₐY_{b}Z_{c} wherein X and Y are selected from the group consisting of Na, K, Li, Fe, Ni, Co, Mn, Cu, Al, and Si; Z is selected from the group consisting of O, OH, Cl, Br, I, F, S, N, SO₄, and ClO₄; and a, b, and c each range from 0.001 to 99.999.

In some embodiments, the salt solution comprises alkali cations and chloride anions.

In some embodiments, the salt solution comprises alkali cations and sulfate anions.

In some embodiments, additional salts are added to the salt solution.

In some embodiments, a cell comprising a cathode, a separator, and an anode is used in (b).

In some embodiments, a cell stack comprising of repeating units of a cathode, a separator, and an anode is used in (b), and are electrically connected in series.

In some embodiments, a cell comprising a cathode, a separator, an anode, and a number of repeating units in between the separator and anode consisting of a bipolar membrane and a separator is used in (b).

In some embodiments, the cathode produces hydrogen gas and the anode consumes hydrogen gas.

In some embodiments, the cathode comprises Pt, Pd, Ni, Ir, Rh, Co, Ru, Fe, Mn, Ti, Zr, Au, Ag, Cu, Pb, Bi, and/or carbon.

In some embodiments, the anode comprises Pt, Pd, Ni, Ir, Iridium Oxide, Rh, Co, Ru, Ruthenium Oxide, Fe, Mn, Ti, Zr, Au, Ag, Cu, Pb, Bi, and/or carbon.

In some embodiments, the separator comprises an ion exchange membrane or a diaphragm.

In some embodiments, an electrical current between 10 and 2000 mA/cm² is applied.

In some embodiments, the salt solution is flowed at a rate of 0.001 to 100 mL/min/cm² through the cathode and anode compartments.

In some embodiments, the salt solution is pH 0-14. In other embodiments, the salt solution is pH 7-14.

In some embodiments, the pH of the solution of lower pH is 0-7.

In some embodiments, the pH of the solution of higher pH is 7-14.

In some embodiments, the solution of lower pH is stored and/or recirculated to the electrochemical cell prior to exposure to the silicate-containing material.

In some embodiments, the solution of higher pH is stored and/or recirculated to the electrochemical cell prior to exposure to the solution generated in (d).

In some embodiments, the solution generated in (d) is separated from remaining silicate-containing material before (e).

In some embodiments, the solution generated in (d) is not separated from remaining silicate-containing material before (e).

In some embodiments, carbonate salt is added to salt solution to precipitate cations.

In some embodiments, the salt solution is contacted with CO₂ prior to recirculation to the electrochemical cell.

In some embodiments, the precipitate generated in (e) is a substantially amorphous material, a crystalline material, or a mixture thereof.

In some embodiments, the precipitate generated in (e) is subsequently reduced with hydrogen gas to form a transition metal.

In some embodiments, the precipitate generated in (e) is subsequently reduced with carbon/carbon monoxide to form a transition metal.

In some embodiments, the reduction is performed in the presence of CaCO₃.

In some embodiments, the precipitate generated in (e) is subject to an electrowinning process for extracting transition metals.

Another aspect of the present invention provides a method for extracting a transition metal ion-containing precipitate comprising:
a. providing a salt solution;
b. performing electrochemical reactions in the salt solution to produce a solution of lower pH and a solution of higher pH;
c. providing a silicate-containing material containing transition metal ions, e.g. silicate-containing Ni laterites;
d. treating the silicate-containing material with the solution of lower pH to dissolve at least a portion of the silicate-containing material and generate a solution with higher pH;
e. treating the treated silicate-contain material generated in (d) with the solution of higher pH to dissolve at least a portion of the silicate-containing material and generate a second solution with lower pH;
f. combining the solution generated in (d) with at least a portion of the solution generated in (e) to form the transition metal ion-containing precipitate and a second salt solution; and
g. recycling the salt solution formed in (f) by adding the salt solution to (b).

In some embodiments, (g) is optional.

In some embodiments, the silicate-containing material comprises less than 30% Si by mass.

In some embodiments, the silicate-containing material comprises a ratio of O to Si greater than or equal to 3:1.

In some embodiments, the precipitate comprises XₐY_{b}Z_{c} wherein X and Y are selected from the group consisting of Na, K, Li, Ca, Mg, Fe, Ni, Co, Mn, Cu, Al, and Si; Z is selected from the group consisting of O, OH, CI, Br, I, F, S, N, SO₄, and ClO₄; and a, b, and c each range from 0.001 to 99.999.

In some embodiments, the salt solution comprises alkali cations and chloride anions.

In some embodiments, the salt solution comprises alkali cations and sulfate anions.

In some embodiments, additional salts are added to the salt solution.

In some embodiments, a cell comprising a cathode, a separator, and an anode is used in (b)

In some embodiments, a cell stack comprising of repeating units of a cathode, a separator, and an anode is used in (b), and the units are electrically connected in series.

In some embodiments, wherein a cell comprising a cathode, a separator, an anode, and a number of repeating units in between the separator and anode consisting of a bipolar membrane and a separator is used in (b).

In some embodiments, wherein the cathode produces hydrogen gas and the anode consumes hydrogen gas.

In some embodiments, the cathode comprises Pt, Pd, Ni, Ir, Rh, Co, Ru, Fe, Mn, Ti, Zr, Au, Ag, Cu, Pb, Bi, and/or carbon.

In some embodiments, the anode comprises Pt, Pd, Ni, Ir, Iridium Oxide, Rh, Co, Ru, Ruthenium Oxide, Fe, Mn, Ti, Zr, Au, Ag, Cu, Pb, Bi, and/or carbon.

In some embodiments, the separator comprises an ion exchange membrane or a diaphragm.

In some embodiments, an electrical current between 10 and 2000 mA/cm² is applied.

In some embodiments, the salt solution is flowed at a rate of 0.1 to 100 mL/min/cm² through the cathode and anode compartments.

In some embodiments, the salt solution is pH 0-14. In other embodiments, the salt solution is pH 7-14.

In some embodiments, the pH of the solution of lower pH is 0-7.

In some embodiments, the pH of the solution of higher pH is 7-14.

In some embodiments, the solution of lower pH is stored and/or recirculated to the electrochemical cell prior to exposure to the silicate-containing material.

In some embodiments, the solution of higher pH is stored and/or recirculated to the electrochemical cell prior to exposure to the solution generated in (d).

In some embodiments, the solution generated in (d) is separated from remaining silicate-containing material before (f) and/or the solution generated in (e) is separated from remaining silicate-containing material before (f).

In some embodiments, the solution generated in (d) is not separated from remaining silicate-containing material before (f) the solution generated in (e) is not separated from remaining silicate-containing material before (f).

In some embodiments, carbonate salt is added to salt solution to precipitate cations.

In some embodiments, the salt solution is contacted with CO₂ prior to recirculation to the electrochemical cell.

In some embodiments, the precipitate generated in (f) is a substantially amorphous material, a crystalline material, or a mixture thereof.

In some embodiments, the precipitate generated in (e) is subsequently reduced with hydrogen gas to form a transition metal.

In some embodiments, the precipitate generated in (e) is subsequently reduced with carbon/carbon monoxide to form a transition metal.

In some embodiments, the reduction is performed in the presence of CaCO₃.

In some embodiments, the precipitate generated in (e) is subject to an electrowinning process for extracting transition metals.

### EXAMPLES

The invention is further described in the following examples, which do not limit the scope of the invention described in the claims.

### Example 1: Electrochemical Generation of Acidic and Basic Solutions at Low Voltage

An electrochemical cell with 1 cm² active area was assembled using a PtNi/C cathode with 0.88 mg cm⁻² Pt loading (De Nora), a Pt/C anode with 0.5 mg cm⁻² Pt loading (De Nora), and a Zirfon PERL UTP 500 separator. The cell was operated galvanostatically at 50, 100, 250 and 500 mA cm⁻² when flowing 3 M NaCl, 0.75 M Na₂SO₄, or a mixed electrolyte of 3 M NaCl and 0.75 M Na₂SO₄ through both the cathode and anode compartments at flow rates of 0.1 mL min⁻¹ through each compartment. The anode was supplied with H₂ gas, which was oxidized to protons and electrons and the cathode performed water reduction to generate H₂ and hydroxide ions. The performance characteristics (cell voltage, current efficiency, and acid/base output concentration) of the electrochemical cell are shown as a function of applied current density in Table 1. The cell voltages refer to the voltage measured between the cathode and anode during operation and are the average values for the last 5 min of each run. Acid is in the form of H₃O⁺ for the NaCl electrolyte and HSO₄⁻ and H₃O⁺ for the electrolytes with Na₂SO₄. The acid-base current efficiency and the concentrations of acid and base were determined by adding MgCl₂ to the catholyte collected from the cell to precipitate Mg(OH)₂ and weighing the isolated Mg(OH)₂.

TABLE 1

| | Current | Cell | Current | [Acid/Base |
|---|---|---|---|---|
| | Density | Voltage | Efficiency | Output] |
| Electrolyte | (mA cm⁻²) | (V) | (%) | (M) |
| 3 M NaCl/0.75 M | 50 | −0.942 | 76.3 | 0.237 |
| Na₂SO₄ | | | | |
| 3 M NaCl/0.75 M | 100 | −1.086 | 59.7 | 0.371 |
| Na₂SO₄ | | | | |
| 3 M NaCl/0.75 M | 250 | −1.392 | 51.5 | 0.800 |
| Na₂SO₄ | | | | |
| 3 M NaCl/0.75 M | 500 | −1.813 | 37.4 | 1.161 |
| Na₂SO₄ | | | | |
| 3 M NaCl | 50 | −0.936 | 65.7 | 0.204 |
| 3 M NaCl | 100 | −1.068 | 51.3 | 0.319 |
| 3 M NaCl | 250 | −1.374 | 37.9 | 0.589 |
| 3 M NaCl | 500 | −1.787 | 31.5 | 0.981 |
| 0.75 M Na₂SO₄ | 50 | −0.936 | 67.2 | 0.209 |
| 0.75 M Na₂SO₄ | 100 | −1.095 | 49.4 | 0.307 |
| 0.75 M Na₂SO₄ | 250 | −1.435 | 30.3 | 0.471 |
| Na₂SO₄ | 500 | −1.826 | 23.2 | 0.720 |

### Example 2: Electrochemical Generation of Acidic and Basic Solutions at Low Voltage

The electrochemical cell described in Example 1 was operated for 16 h with a mixed electrolyte containing 3 M NaCl and 0.75 M Na₂SO₄ flowing through both the anode and cathode compartments at 0.15 mL min⁻¹ using a duty cycle of 10,000 s at 100 mA cm⁻² followed by 50 s at 100 mA cm⁻² with reverse cell polarity, with this cycle repeated 5 times, then 7,600 s at 100 mA cm⁻² followed by 50 s at 100 mA cm⁻² with reverse cell polarity. FIG. 2 shows the measured cell voltage vs time. The cell voltage gradually increases over the long period of the duty cycle and the brief period of operation at reverse cell polarity restores the cell voltage to its original value. The current efficiency was determined by using the anolyte and catholyte to transform olivine into CDR material according to the procedure described in Example 3 below and obtaining gravimetric and elemental analysis of the isolated byproduct and CDR material. The current efficiency for the 16 h run was determined to be 72%.

### Example 3: Transformation of Olivine into CDR Material and Characterization of its Reactivity with CO₂

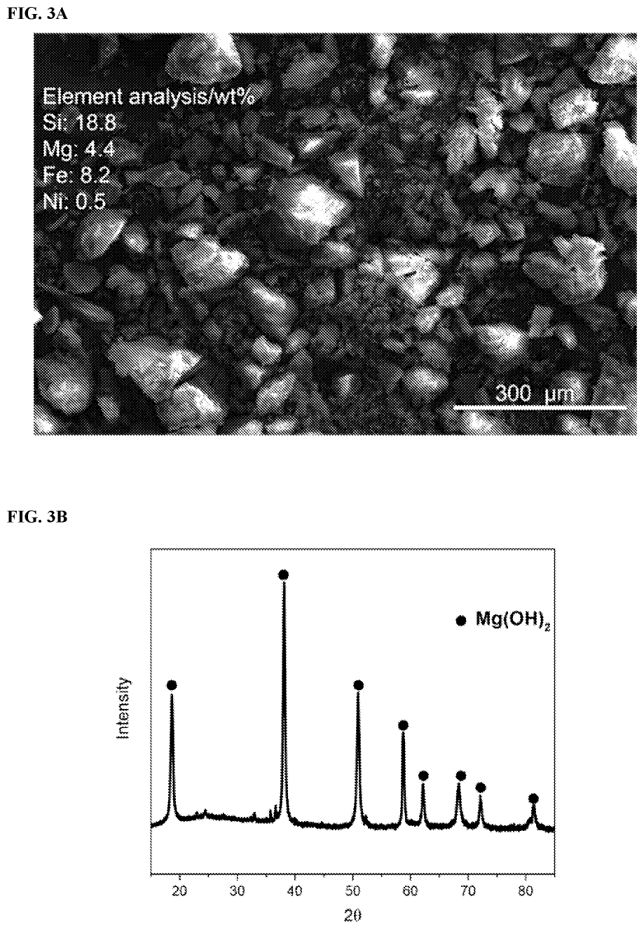

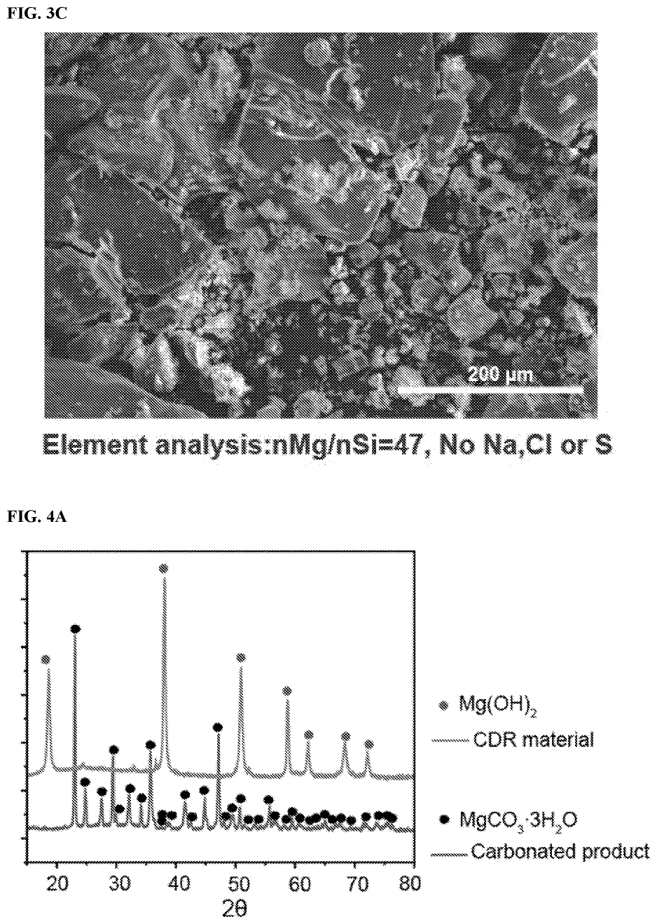

Olivine (Mg_{1.9}Fe_{0.1}SiO₄) was crushed and sieved to produce a sample with particle sizes ~149 μm. The electrochemical cell was operated with a mixed electrolyte (3 M NaCl and 0.75 M Na₂SO₄) to generate acidic anolyte and basic catholyte solutions. The anolyte from the output of the electrochemical cell was contacted with the sieved olivine in a flask until the pH was raised to between 3 and 4 to form a leachate solution. The leachate solution was separated from the residual solid by filtration. The catholyte from the output of the electrochemical cell was added into the filtered leachate solution to adjust the pH to between 8 and 9, which caused a precipitate to form (the byproduct). This byproduct was isolated by centrifugation. Then the remaining catholyte was added to the centrifuged solution to precipitate the CDR material, which was isolated by centrifugation. FIG. 3A shows SEM and EDS analysis of a byproduct isolated after raising the pH of the leachate solution to between 8 and 9. The EDS analysis indicates an elemental composition of 18 wt % Si, 4.42 wt % Mg, 8.2 wt % Fe, and 0.5 wt % Ni, which is consistent with a material containing SiO₂, MgSiO₃, Fe(OH)₂, Fe(OH)₃, and Ni(OH)₂. FIG. 3B and FIG. 3C show powder X-ray diffraction (pXRD) and SEM/EDS analysis of CDR material isolated after filtering off the byproduct from the leachate and adding the rest of the catholyte solution. The CDR material has a particle size ranging from 10-200 μm and contains crystalline Mg(OH)₂. EDS analysis shows a Mg:Si ratio of 47, indicating only a small Si impurity in the Mg(OH)₂. No electrolyte components (Na, Cl, S) were detected in the CDR material by EDS.

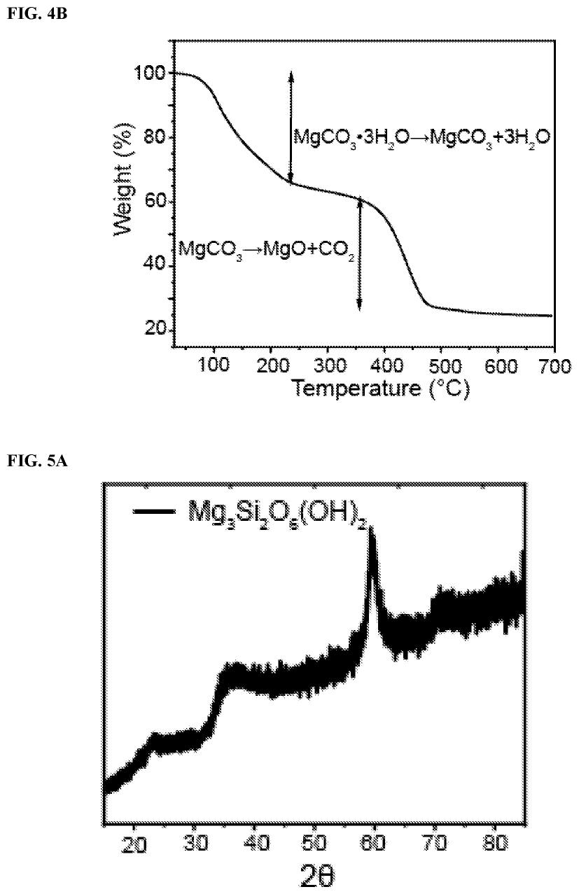

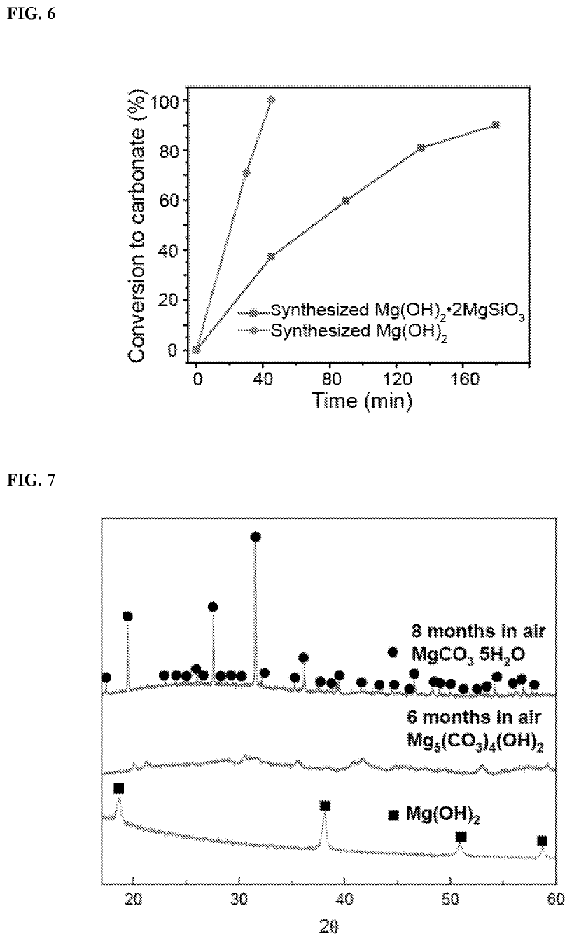

Carbonation of the isolated CDR material was tested by suspending 50 mg of the CDR material in 10 mL deionized H₂O and bubbling CO₂ through the solution at ambient pressure and temperature at 10 mL min⁻¹. At different timepoints, aliquots of the solution were removed, filtered and dried at 40° C. to form a solid. Analysis by pXRD (FIG. 4A) and thermogravimetric analysis (TGA) (FIG. 4B) indicated that the solid product is MgCO₃·3H₂O. The amount of MgCO₃·3H₂O isolated vs time was used to determine the extent of carbonation. FIG. 6 shows the carbonation of CDR material derived from olivine to the carbonation of CDR material derived from serpentine (see Example 4 below) vs time. The CDR material derived from olivine reaches complete carbonation in 45 min.

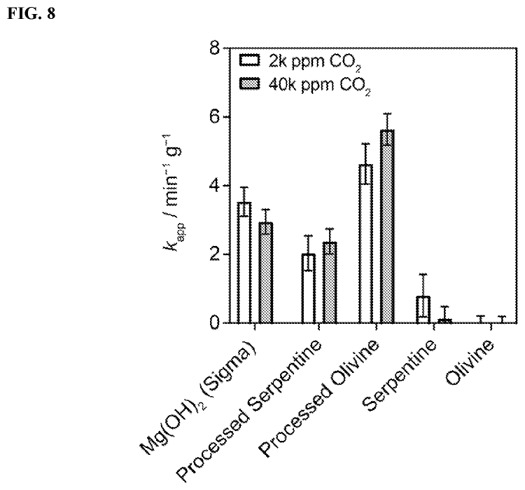

The rate of carbonation of the CDR material was quantified by passing a mixed gas stream of Ar and CO₂ through a suspension of 0.5 g of the CDR material in 1 mL of water. The gas stream was subsequently passed through an in-line mass spectrometer for real-time quantification of the CO₂ concentration. The CO₂ concentration in the output gas stream was subtracted from that for a blank cell containing no CDR material to obtain the instantaneous rate of CO₂ uptake. The CO₂ concentration normalized rate constants for uptake are shown in FIG. 8. Whereas the rate constant for CO₂ uptake by olivine is not measureable, the rate constant for CO₂ uptake by the CDR material (labeled processed olivine) is slightly greater than that of pure Mg(OH)₂ at input CO₂ concentrations of 2000 and 40000 ppm.

### Example 4: Transformation of Serpentine to CDR Material and Characterization of its Reactivity with CO₂

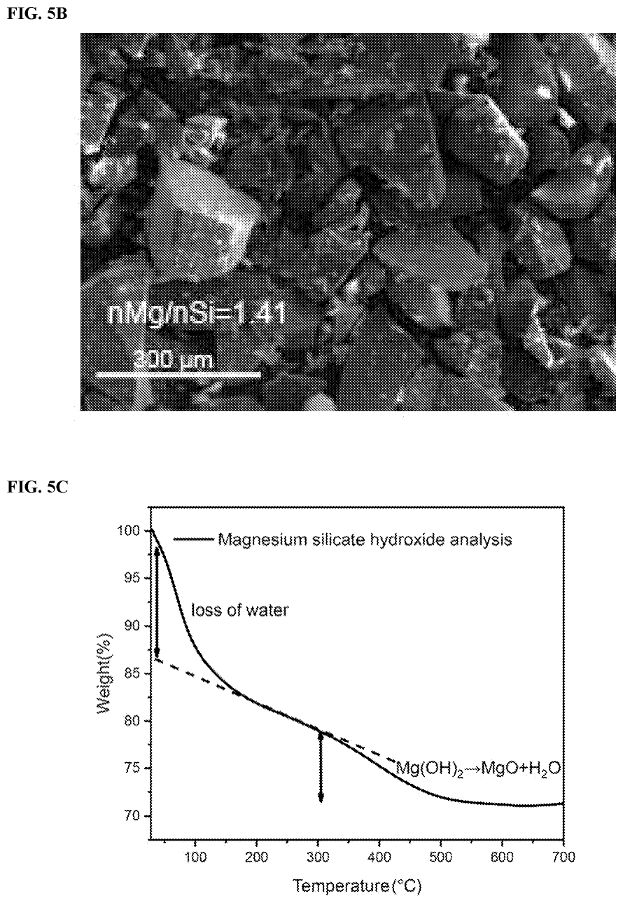

A glass column was used to flow solutions over rock samples. The column was packed with 25 g of crushed serpentine (chrysotile, Mg₃Si₂O₅(OH)₄) with 50-75 μm particle size. An electrochemical cell like the one described in Example 1 was operated with a mixed electrolyte (NaCl and Na₂SO₄). Anolyte from the output of the electrochemical cell was flowed through the column and recirculated at a rate of 0.3 mL min⁻¹ until the outlet pH was between 3 and 4 to form an acidic leachate solution. Then catholyte from the output of the electrochemical cell was flowed through the column and recirculated at a rate of 0.3 mL min⁻¹ until the outlet pH was between 12 and 13 to form a basic leachate solution. The acidic leachate solution was added to the basic leachate solution to precipitate a CDR material, which was isolated by centrifugation. Powder X-ray diffraction (pXRD) of the CDR material showed very broad peaks, indicating the solid is substantially amorphous (FIG. 5A). SEM-EDS shows a material with 100-300 μm particle sizes and a Mg:Si ratio of 1.41 (FIG. 5B). TGA of the CDR material shows a weight loss at ~400° C., which is consistent with dehydration of Mg(OH)₂ in hydrated silicate (FIG. 5C). The EDS and TGA results are consistent with a solid that is predominantly Mg₃Si₂O₆ (OH)₂.

Carbonation of the isolated CDR material obtained from serpentine was tested by suspending 50 mg of the CDR material in 10 mL deionized H₂O and bubbling CO₂ through the solution at ambient pressure and temperature at 10 mL min⁻¹. At different timepoints, aliquots of the solution were removed, filtered and dried to form a solid. TGA analysis of the solid indicated it was MgCO₃·3H₂O. The amount of MgCO₃·3H₂O isolated vs time was used to determine the extent of carbonation. FIG. 6 shows compares the carbonation of CDR material derived from olivine to the carbonation of CDR material derived from serpentine vs time. The CDR material derived from serpentine reaches >90% carbonation in 3 h.

The rate of carbonation of the CDR material was quantified by passing a mixed gas stream of Ar and CO₂ through a suspension of 0.5 g of the CDR material in 1 mL of water. The gas stream was subsequently passed through an in-line mass spectrometer for real-time quantification of the CO₂ concentration. The CO₂ concentration in the output gas stream was subtracted from that for a blank cell containing no CDR material to obtain the instantaneous rate of CO₂ uptake. The CO₂ concentration normalized rate constants for uptake are shown in FIG. 8. Whereas the rate constant for CO₂ uptake by serpentine is near zero, the rate constant for CO₂ uptake by the CDR material (labeled processed serpentine) is comparable to that of pure Mg(OH)₂ at input CO₂ concentrations of 2000 and 40000 ppm.

### Example 5: Carbonation in Air of CDR Material Derived from Olivine

The carbonation in air of CDR material obtained from olivine was tested. The CDR material was placed in a dish and deionized water (10 g per g CDR material) was added daily to keep the material wet. Aliquots of the material were removed periodically and analyzed by pXRD. The material was carbonated first to form Mg₅(CO₃)₄(OH)₂ within 6 months and further carbonated into MgCO₃·5H₂O within 8 months (FIG. 7).

### Example 6: Reuse of Electrolyte Solution in Electrochemical System for Generating Acidic and Basic Solutions after Contacting Silicate-Containing Material

This experiment demonstrates the ability to operate an electrochemical system for generating acidic and basic solutions using salt solution obtained from precipitating solids from a leachate solution. The electrochemical cell used consisted of a Pt/C anode, a Ni foam cathode, and a diaphragm separator between the anode and cathode compartments. The active area of each electrode was ~1.75 cm². The anode was supplied with H₂ gas, which was oxidized to protons and electrons and the cathode performed water reduction to generate H₂ and hydroxide ions. A 3 M NaCl electrolyte was flowed through the anode compartment at 0.3 mL min⁻¹ and through the cathode compartment at 8.7 mL min⁻¹ while the cell was operated galvanostatically at 92 mA cm⁻². The measured pH of the anolyte exiting the cell was <1 and the measured pH of the catholyte exiting the cell was ~12. The cell was operated for 30 min and the anolyte and catholyte were collected.

A glass column was packed with 25 g of 100 mesh olivine (Mg_{1.9}Fe_{0.1}SiO₄), with particle sizes >149 μm. The anolyte collected from the outlet of the electrochemical cell was flowed through the column and recirculated at a rate of 0.3 mL min⁻¹ until the outlet pH was between 3 and 4 (>99% proton consumed). The solution obtained after contacting the olivine was then combined with the catholyte solution from the electrochemical cell, which resulted in precipitation of a solid. The solid was removed by centrifugation, washed with water three times, and dried at 80° C. under vacuum. The filtered solution was reused in the electrochemical cell to regenerate anolyte and catholyte solutions and the entire process was repeated four times. Table 2 shows EDS analysis of the solid obtained after 4 repeat cycles using the same recycled 3 M NaCl electrolyte. A sample of the product material was also analyzed by TGA. According to SEM-EDS and TGA analysis, the formula of the solid is calculated to be Mg₃SiO₃ (OH)₄.

TABLE 2
Composition of solid obtained from processing olivine with acidic
and basic solutions generated from an electrochemical system
operated with recycled salt solution.

| | 1ₛₜ run | 2_{nd} run | 3_{rd} run | 4ₜₕ run |
|---|---|---|---|---|
| Mg | 1 | 1 | 1 | 1 |
| Si | 0.34 | 0.46 | 0.41 | 0.36 |
| Fe | 0.12 | 0.11 | 0.06 | 0.09 |
| Cl | 0.02 | 0.003 | 0.01 | 0.01 |

The catholyte after 5 runs was analyzed by ICP (Table 3). The low concentration of Mg²⁺ shows that most of the Mg²⁺ is precipitated in each cycle.

TABLE 3
ICP analysis of the catholyte after operation of an electrochemical
system operated with recycled salt solution.

| Element | Concentration (mg/L) | Concentration (mmol/L) |
|---|---|---|
| Na | 67.7 g/L | 2.94 mol/L |
| Mg | 4.4 | 0.18 |
| Si | 18 | 0.64 |
| Fe | <1 | |

*Only showing elements that are present at concentrations >1 mg/L

### INCORPORATION BY REFERENCE

All of the U.S. patents and U.S. and PCT published patent applications cited herein are hereby incorporated by reference.

### EQUIVALENTS

The foregoing written specification is considered to be sufficient to enable one skilled in the art to practice the invention. The present invention is not to be limited in scope by examples provided, since the examples are intended as a single illustration of one aspect of the invention and other functionally equivalent embodiments are within the scope of the invention. Various modifications of the invention in addition to those shown and described herein will become apparent to those skilled in the art from the foregoing description and fall within the scope of the appended claims. The advantages and objects of the invention are not necessarily encompassed by each embodiment of the invention.

What is claimed is:

1. A method of forming a precipitate, comprising:
a. providing a salt solution;
b. performing electrochemical reactions in the salt solution to produce a solution of lower pH and a solution of higher pH;
c. providing a silicate-containing material containing Mg²⁺ and/or Ca²⁺ ions;
d. treating the silicate-containing material with the solution of lower pH to dissolve at least a portion of the silicate-containing material to generate a second solution with higher pH;
e. combining the solution generated in (d) with at least a portion of the solution with higher pH generated in (b) to form the precipitate and a second salt solution; and
f. recycling the salt solution formed in step (e) by adding the salt solution to (b).

2. The method of claim 1, wherein the silicate-containing material comprises less than 30% Si by mass.

3. The method of claim 1, wherein the silicate-containing material comprises a ratio of O to Si greater than or equal to 3:1.

4. The method of claim 1, wherein the precipitate comprises XₐY_{b}Z_{c}, wherein X and Y are selected from the group consisting of Na, K, Li, Ca, Mg, Fe, Al, and Si;
Z is selected from the group consisting of O, OH, Cl, Br, I, F, S, N, SO₄, and ClO₄; and
a, b, and c each range from 0.001 to 99.999.

5. The method of claim 1, wherein the salt solution comprises alkali cations and chloride anions.

6. The method of claim 1, wherein the salt solution comprises alkali cations and sulfate anions.

7. The method of claim 5 or 6, wherein additional salts are added to the salt solution.

8. The method of claim 1, where (b) comprises performing electrohydrolysis

9. The method of claim 1, where (b) comprises bipolar membrane electrodialysis.

10. The method of claim 1, wherein a cell comprising a cathode, an anode, and a separator is used in (b).

11. The method of claim 1, wherein a cell stack comprising repeating units of a cathode, a separator, and an anode is used in (b), and the units are electrically connected in series.

12. The method of claim 1, where a cell comprising a cathode, a separator, an anode, and a number of repeating units in between the separator and anode consisting of a bipolar membrane and a separator is used in (b).

13. The method of any one of claims 10-12, wherein the cathode produces hydrogen gas and the anode consumes hydrogen gas.

14. The method of any one of claims 10-13, wherein the cathode comprises Pt, Pd, Ni, Ir, Rh, Co, Ru, Fe, Mn, Ti, Zr, Au, Ag, Cu, Pb, Bi, and/or carbon.

15. The method of any one of claims 10-13, wherein the anode comprises Pt, Pd, Ni, Ir, Iridium Oxide, Rh, Co, Ru, Ruthenium Oxide, Fe, Mn, Ti, Zr, Au, Ag, Cu, Pb, Bi, and/or carbon.

16. The method of any one of claims 10-15, wherein the separator comprises an ion exchange membrane or diaphragm.

17. The method of any one of claims 10-16, wherein an electrical current from 10 to 2000 mA/cm² is applied.

18. The method of any one of claims claim 10-17, wherein the salt solution is flowed at a rate of 0.1 to 100 mL/min/cm² through the cathode and anode compartments.

19. The method of any one of claims claim 1-18, wherein the salt solution is pH 0-14.

20. The method of any one of claims claim 1-18, wherein the salt solution is pH 7-14.

21. The method of any one of claims claim 1-20, wherein the solution of lower pH range is pH 0-7.

22. The method of any one of claims claim 1-21, wherein the solution of higher pH range is pH 7-14.

23. The method of any one of claims claim 1-22, wherein the solution of lower pH is stored and/or recirculated to the electrochemical cell prior to exposure to the silicate-containing material.

24. The method of any one of claims claim 1-22, wherein the solution of higher pH is stored and/or recirculated to the electrochemical cell prior to exposure to the solution generated in (d).

25. The method of any one of claims claim 1-24, wherein the solution generated in (d) is separated from remaining silicate-containing material before (e).

26. The method of any one of claims claim 1-24, wherein the solution generated in (d) is not separated from remaining silicate-containing material before (e).

27. The method of any one of claims claim 1-26, wherein carbonate salt is added to the salt solution to precipitate cations.

28. The method of any one of claims 1-27, wherein the salt solution is contacted with CO₂ prior to recirculation to (b).

29. The method of any one of claims 1-28, wherein the precipitate generated in (e) comprises a substantially amorphous material, a crystalline material, or a mixture thereof.

30. The method of any one of claims 1-28, wherein the precipitate generated in (e) is added to agricultural soils.

31. The method of any one of claims 1-28, wherein the precipitate generated in (e) is added to body of water.

32. The method of any one of claims 1-28, wherein the precipitate generated in (e) is added to land-fill.

33. The method of any one of claims 1-28, wherein the precipitate generated in (e) is distributed over land.

34. The method of any one of claims 1-28, wherein the precipitate generated in (e) is added to a cement.

35. A method for sequestering carbon dioxide comprising:
a. providing a salt solution;
b. performing electrochemical reactions in the salt solution to produce a solution of lower pH and a solution of higher pH;
c. providing a silicate-containing material containing Mg²⁺ and/or Ca²⁺ ions;
d. treating the silicate-containing material with the solution of lower pH to dissolve at least a portion of the silicate-containing material and generate a second solution with higher pH;
e. combining the solution generated in (d) with at least a portion of the solution with higher pH generated in (b) to form a precipitate and a second salt solution;
f. recycling the salt solution formed in (e) by adding the salt solution to (b); and
g. exposing the precipitate formed in (e) to a CO₂-containing gas.

36. The method of claim 35, wherein the silicate-containing material comprises less than 30% Si by mass.

37. The method of claim 35, wherein the silicate-containing material comprises a ratio of O to Si greater than or equal to 3:1.

38. The method of claim 35, wherein the precipitate comprises XₐY_{b}Z_{c} wherein
X and Y are selected from the group consisting of Na, K, Li, Ca, Mg, Fe, Al, and Si;
Z is selected from the group consisting of O, OH, Cl, Br, I, F, S, N, SO₄, and ClO₄; and
a, b, and c each range from 0.001 to 99.999.

39. The method of claim 35, wherein the salt solution comprises alkali cations and chloride anions.

40. The method of claim 35, wherein the salt solution comprises alkali cations and sulfate anions.

41. The method of any of claims 39-40, wherein additional salts are added to the salt solution.

42. The method of claim 35, where (b) comprises performing electrohydrolysis.

43. The method of claim 35, where (b) comprises bipolar membrane electrodialysis

44. The method of claim 35, wherein a cell comprising a cathode, an anode, and a separator is used in (b).

45. The method of claim 35, wherein a cell stack comprising repeating units of a cathode, a separator, and an anode is used in (b), and the units are electrically connected in series.

46. The method of claim 35, where a cell comprising a cathode, a separator, an anode, and a number of repeating units in between the separator and anode consisting of a bipolar membrane and a separator is used in (b).

47. The method of any one of claims 44-46, wherein the cathode produces hydrogen gas and the anode consumes hydrogen gas.

48. The method of any one of claims 44-47, wherein the cathode comprises Pt, Pd, Ni, Ir, Rh, Co, Ru, Fe, Mn, Ti, Zr, Au, Ag, Cu, Pb, Bi, and/or carbon.

49. The method of any one of claims 44-48, wherein the anode comprises Pt, Pd, Ni, Ir, Iridium Oxide, Rh, Co, Ru, Ruthenium Oxide, Fe, Mn, Ti, Zr, Au, Ag, Cu, Pb, Bi, and/or carbon.

50. The method of any one of claims 44-49, wherein the separator comprises an ion exchange membrane or a diaphragm.

51. The method of any one of claims 44-50, wherein an electrical current from 10 to 2000 mA/cm² is applied.

52. The method of any one of claims 44-51, wherein the salt solution is flowed at a rate of 0.1 to 100 mL/min/cm² through the cathode and anode compartments.

53. The method of any one of claims claim 35-52, wherein the salt solution is pH 0-14.

54. The method of any one of claims claim 35-52, wherein the salt solution is pH 7-14.

55. The method of any one of claims claim 35-54, wherein the solution of lower pH is pH 0-7.

56. The method of any one of claims claim 35-55, wherein the solution of higher pH range is pH 7-14.

57. The method of any one of claims claim 35-56, wherein the solution of lower pH is stored and/or recirculated to the electrochemical cell prior to exposure to the silicate-containing material.

58. The method of any one of claims claim 35-56, wherein the solution of higher pH is stored and/or recirculated to the electrochemical cell prior to exposure to the solution generated in (d).

59. The method of any one of claims claim 35-56, wherein the solution generated in (d) is separated from remaining silicate-containing material before (e).

60. The method of any one of claims claim 35-59, wherein the solution generated in (d) is not separated from remaining silicate-containing material before (e).

61. The method of any one of claims claim 35-60, wherein carbonate salt is added to salt solution to the precipitate cations.

62. The method of any one of claims claim 35-61, wherein the salt solution is contacted with CO₂ prior to recirculation to (b).

63. The method of any one of claims 35-62, wherein the precipitate generated in (e) is a substantially amorphous material, a crystalline material, or a mixture thereof.

64. The method of any one of claims 35-63, wherein the precipitate generated in (e) is added to agricultural soils.

65. The method of any one of claims 35-63, wherein the precipitate generated in (e) is added to a body of water.

66. The method of any one of claims 35-63, wherein the precipitate generated in (e) is added to land-fill.

67. The method of any one of claims 35-63, wherein the precipitate generated in (e) is distributed over land.

68. The method of any one of claims 35-63, wherein the precipitate generated in (e) is added to a cement.

69. The method of any one of claims 35-68, where the CO₂-containing gas in (g) is air.

70. The method of any one of claims 35-68, where the CO₂-containing gas in (g) comprises at least 1% CO₂.

71. The method of any one of claims 35-70, where the precipitate generated in (e) reacts with 1 atm of CO₂ in H₂O at <30° C. to form a magnesium carbonate or magnesium bicarbonate in >10% yield in less than 1 h.

72. A method of forming a precipitate comprising:
a. providing a salt solution;
b. performing electrochemical reactions in the salt solution to produce a solution of lower pH and a solution of higher pH;
c. providing a silicate-containing material containing Mg²⁺ and/or Ca²⁺ ions;
d. treating the silicate-containing material with the solution of lower pH to dissolve at least a portion of the silicate-containing material and generate a second solution with higher pH;
e. treating the treated silicate-contain material generated in (d) with the solution of higher pH to dissolve at least a portion of the silicate-containing material and generate a second solution with lower pH;
f. combining the solution generated in (d) with at least a portion of the solution generated in (e) to form the precipitate and a second salt solution; and
g recycling the salt solution formed in (f) by adding the salt solution to (b).

73. The method of claim 72, wherein the silicate-containing material comprises less than 30% Si by mass.

74. The method of claim 72, wherein the silicate-containing material comprises a ratio of O to Si greater than or equal to 3:1.

75. The method of claim 72, wherein the precipitate comprises XₐY_{b}Z_{c}, wherein
X and Y are selected from the group consisting of Na, K, Li, Ca, Mg, Fe, and Al, Si;
Z is selected from the group consisting of O, OH, Cl, Br, I, F, S, N, SO₄, and ClO₄; and
a, b, and c each range from 0.001 to 99.999.

76. The method of claim 72, wherein the salt solution comprises alkali cations and chloride anions.

77. The method of claim 72, wherein the salt solution comprises alkali cations and sulfate anions.

78. The method of claims 76-77, wherein additional salts are added to the salt solution.

79. The method of claim 72, where (b) comprises performing electrohydrolysis

80. The method of claim 72, where (b) comprises bipolar membrane electrodialysis.

81. The method of claim 72, wherein a cell comprising a cathode, an anode, and a separator is used in (b).

82. The method of claim 72, wherein a cell stack comprising repeating units of a cathode, a separator, and an anode is used in (b), and the units are electrically connected in series.

83. The method of claim 72, where a cell comprising a cathode, a separator, an anode, and a number of repeating units in between the separator and anode consisting of a bipolar membrane and a separator is used in (b).

84. The method of any one of claims 81-83, wherein the cathode produces hydrogen gas and the anode consumes hydrogen gas.

85. The method of claim 81-84, wherein the cathode comprises Pt, Pd, Ni, Ir, Rh, Co, Ru, Fe, Mn, Ti, Zr, Au, Ag, Cu, Pb, Bi, and/or carbon.

86. The method of claim 81-85, wherein the anode comprises Pt, Pd, Ni, Ir, Iridium Oxide, Rh, Co, Ru, Ruthenium Oxide, Fe, Mn, Ti, Zr, Au, Ag, Cu, Pb, Bi, and/or carbon.

87. The method of claim 81-86, wherein the separator comprises an ion exchange membrane or diaphragm.

88. The method of any one of claims 81-86, wherein an electrical current from 10 to 2000 mA/cm² is applied.

89. The method of any one of claims 81-86, wherein the salt solution is flowed at a rate of 0.1 to 100 mL/min/cm² through the cathode and anode compartments.

90. The method of any one of claims 72-89, wherein the salt solution is pH 0-14.

91. The method of any one of claims 72-89, wherein the salt solution is pH 7-14.

92. The method of any one of claims 72-91, wherein the solution of lower pH range is pH 0-7.

93. The method of any one of claims 72-92, wherein the solution of higher pH range is pH 7-14.

94. The method of any one of claims 72-93, wherein the solution of lower pH is stored and/or recirculated to the electrochemical cell prior to exposure to the silicate-containing material.

95. The method of any one of claims 72-94, wherein the solution of higher pH is stored and/or recirculated to the electrochemical cell prior to exposure to the silicate-containing material generated in (d).

96. The method of any one of claims 72-95, wherein the solution generated in (d) is separated from remaining silicate-containing material before (f) and/or the solution generated in (e) is separated from remaining silicate-containing material before (f).

97. The method of any one of claims 72-95, wherein the solution generated in (d) is not separated from remaining silicate-containing material before (f) and/or the solution generated in (e) is not separated from remaining silicate-containing material before (f).

98. The method of claim any one of claims 72-97, wherein carbonate salt is added to the salt solution to precipitate cations.

99. The method of claim any one of claims 72-98, wherein the second salt solution is contacted with CO₂ prior to recirculation to (b).

100. The method of any one of claims 72-99, wherein the precipitate generated in (f) comprises a substantially amorphous material, a crystalline material, or a mixture thereof.

101. The method of any one of claims 72-100, wherein the precipitate generated in (f) is added to agricultural soils.

102. The method of any one of claims 72-100, wherein the precipitate generated in (f) is added to body of water.

103. The method of any one of claims 72-100, wherein the precipitate generated in (f) is added to land-fill.

104. The method of any one of claims 72-100, wherein the precipitate generated in (f) is distributed over land.

105. The method of any one of claims 72-100, wherein the precipitate generated in (f) is added to a cement.

106. A method for sequestering carbon dioxide comprising:
a. providing a salt solution;
b performing electrochemical reactions in the salt solution to produce a solution of lower pH and a solution of higher pH;
c. providing a silicate-containing material containing Mg²⁺ and/or Ca²⁺ ions
d. treating the silicate-containing material with the solution of lower pH to dissolve at least a portion of the silicate-containing material and generate a second solution with higher pH;
e. treating the treated silicate-contain material generated in (d) with the solution of higher pH to dissolve at least a portion of the silicate-containing material and generate a second solution with lower pH;
f. combining the solution generated in (d) with at least a portion of the solution generated in (e) to form a precipitate and a second salt solution;
g. recycling the salt solution formed in (f) by adding the salt solution to (b); and
h exposing the precipitate formed in (f) to a CO₂-containing gas.

107. The method of claim 106, wherein the silicate-containing material comprises less than 30% Si by mass.

108. The method of claim 106, wherein the silicate-containing material comprises a ratio of O to Si greater than or equal to 3:1.

109. The method of claim 106, wherein the precipitate comprises XₐY_{b}Z_{c} wherein
X and Y are selected from the group consisting of Na, K, Li, Ca, Mg, Fe, Al, and Si;
Z is selected from the group consisting of O, OH, Cl, Br, I, F, S, N, SO₄, and ClO₄; and
a, b, and c each range from 0.001 to 99.999.

110. The method of claim 106, wherein the salt solution comprises alkali cations and chloride anions.

111. The method of claim 106, wherein the salt solution comprises alkali cations and sulfate anions.

112. The method of any of claims 110-111, wherein additional salts are added to the salt solution.

113. The method of claim 106, where (b) comprises performing electrohydrolysis.

114. The method of claim 106, where (b) comprises bipolar membrane electrodialysis

115. The method of claim 106, wherein a cell comprising a cathode, an anode, and a separator is used in (b).

116. The method of claim 106, wherein a cell stack comprising repeating units of a cathode, a separator, and an anode is used in (b), and the units are electrically connected in series.

117. The method of claim 106, where a cell comprising a cathode, a separator, an anode, and a number of repeating units in between the separator and anode consisting of a bipolar membrane and a separator is used in (b).

118. The method of any one of claims 115-117, wherein the cathode produces hydrogen gas and the anode consumes hydrogen gas.

119. The method of any one of claims 115-118, wherein the cathode comprises Pt, Pd, Ni, Ir, Rh, Co, Ru, Fe, Mn, Ti, Zr, Au, Ag, Cu, Pb, Bi, and/or carbon.

120. The method of any one of claims 115-119, wherein the anode comprises Pt, Pd, Ni, Ir, Iridium Oxide, Rh, Co, Ru, Ruthenium Oxide, Fe, Mn, Ti, Zr, Au, Ag, Cu, Pb, Bi, and/or carbon.

121. The method of any one of claims 115-120, wherein the separator comprises an ion exchange membrane or a diaphragm.

122. The method of any one of claims 115-121, wherein an electrical current between 10 and 2000 mA/cm² is applied.

123. The method of any one of claims 115-122, wherein the salt solution is flowed at a rate of 0.1 to 100 mL/min/cm² through the cathode and anode compartments.

124. The method of any one of claims 106-123, wherein the salt solution is pH 0-14.

125. The method of any one of claims 106-123, wherein the salt solution is pH 7-14.

126. The method of any one of claims 106-125, wherein the solution of lower pH is pH 0-7.

127. The method of any one of claims 106-126, wherein the solution of higher pH range is pH 7-14.

128. The method of any one of claims 106-127, wherein the solution of lower pH is stored and/or recirculated to the electrochemical cell prior to exposure to the silicate-containing material.

129. The method of any one of claims 106-127, wherein the solution of higher pH is stored and/or recirculated to the electrochemical cell prior to exposure to the solution generated in (d).

130. The method of any one of claims 106-129, wherein the solution generated in (d) is separated from remaining silicate-containing material before (f) and/or the solution generated in (e) is separated from remaining silicate-containing material before (f).

131. The method of any one of claims 106-129, wherein the solution generated in (d) is not separated from remaining silicate-containing material before (f) and/or the solution generated in (e) is not separated from remaining silicate-containing material before (f).

132. The method of any one of claims 106-131, wherein carbonate salt is added to the salt solution to precipitate cations.

133. The method of any one of claims 106-132, wherein the second salt solution is contacted with CO₂ prior to recirculation to (b).

134. The method of any one of claims 106-133, wherein the precipitate generated in (f) is a substantially amorphous material, a crystalline material, or a mixture thereof.

135. The method of any one of claims 106-134, wherein the precipitate generated in (f) is added to agricultural soils.

136. The method of any one of claims 106-134, wherein the precipitate generated in (f) is added to a body of water.

137. The method of any one of claims 106-134, wherein the precipitate generated in (f) is added to land-fill.

138. The method of any one of claims 106-134, wherein the precipitate generated in (f) is distributed over land.

139. The method of any one of claims 106-138, wherein the CO₂-containing gas in (g) is air.

140. The method of any one of claims 106-138, wherein the CO₂-containing gas in (g) comprises at least 1% CO₂.

141. The method of any one of claims 106-140, wherein where the precipitate generated in (e) reacts with 1 atm of CO₂ in H₂O at <30° C. to form a magnesium carbonate or magnesium bicarbonate in >10% yield in less than 1 h.

142. A method for extracting a transition metal ion-containing precipitate comprising:
a. providing a salt solution;
b. performing electrochemical reactions in the salt solution to produce a solution of lower pH and a solution of higher pH;
c. providing a silicate-containing material containing transition metal ions, e.g. silicate-containing Ni laterites;
d. treating the silicate-containing material with the solution of lower pH to dissolve at least a portion of the silicate-containing material to generate a solution with higher pH;
e. combining the solution generated in (d) with at least a portion of the solution with higher pH generated in (b) to form the transition metal ion-containing precipitate and a second salt solution; and
f. recycling the salt solution formed in step (e) by adding the salt solution to (b).

143. The method of claim 142, wherein the silicate-containing material comprises less than 30% Si by mass.

144. The method of claim 142, wherein the silicate-containing material comprises a ratio of O to Si greater than or equal to 3:1.

145. The method of claim 142, wherein the precipitate comprises XₐY_{b}Z_{c} wherein
X and Y are selected from the group consisting of Na, K, Li, Fe, Ni, Co, Mn, Cu, Al, and Si;
Z is selected from the group consisting of O, OH, Cl, Br, I, F, S, N, SO₄, and ClO₄; and
a, b, and c each range from 0.001 to 99.999.

146. The method of claim 142, wherein the salt solution comprises alkali cations and chloride anions.

147. The method of claim 142, wherein the salt solution comprises alkali cations and sulfate anions.

148. The method of any of claims 146-147, wherein additional salts are added to the salt solution.

149. The method of claim 142, wherein a cell comprising a cathode, a separator, and an anode is used in (b).

150. The method of claim 142, wherein a cell stack comprising of repeating units of a cathode, a separator, and an anode is used in (b), and are electrically connected in series.

151. The method of claim 142, wherein a cell comprising a cathode, a separator, an anode, and a number of repeating units in between the separator and anode consisting of a bipolar membrane and a separator is used in (b).

152. The method of claims 149-151, wherein the cathode produces hydrogen gas and the anode consumes hydrogen gas.

153. The method of any one of claims 149-152, wherein the cathode comprises Pt, Pd, Ni, Ir, Rh, Co, Ru, Fe, Mn, Ti, Zr, Au, Ag, Cu, Pb, Bi, and/or carbon.

154. The method of any one of claims 149-153, wherein the anode comprises Pt, Pd, Ni, Ir, Iridium Oxide, Rh, Co, Ru, Ruthenium Oxide, Fe, Mn, Ti, Zr, Au, Ag, Cu, Pb, Bi, and/or carbon.

155. The method of any one of claims 149-154, wherein the separator comprises an ion exchange membrane or a diaphragm.

156. The method of any one of claims 149-155, wherein an electrical current between 10 and 2000 mA/cm² is applied.

157. The method of any one of claims 149-156, wherein the salt solution is flowed at a rate of 0.001 to 100 mL/min/cm² through the cathode and anode compartments.

158. The method of any one of claims 142-157, wherein the salt solution is pH 0-14.

159. The method of any one of claims 142-157, wherein the salt solution is pH 7-14.

160. The method of any one of claims 142-159, wherein the pH of the solution of lower pH is 0-7.

161. The method of claim any one of claims 142-160, wherein the pH of the solution of higher pH is 7-14.

162. The method of claim any one of claims 142-161, wherein the solution of lower pH is stored and/or recirculated to the electrochemical cell prior to exposure to the silicate-containing material.

163. The method of any one of claims 142-162, wherein the solution of higher pH is stored and/or recirculated to the electrochemical cell prior to exposure to the solution generated in (d).

164. The method of any one of claims 142-163, wherein the solution generated in (d) is separated from remaining silicate-containing material before (e).

165. The method of any one of claims 142-163, wherein the solution generated in (d) is not separated from remaining silicate-containing material before (e).

166. The method of any one of claims 142-165, wherein carbonate salt is added to salt solution to precipitate cations.

167. The method of any one of claims 142-166, wherein the salt solution is contacted with CO₂ prior to recirculation to the electrochemical cell.

168. The method of any one of claims 142-167, wherein the precipitate generated in (e) is a substantially amorphous material, a crystalline material, or a mixture thereof.

169. The method of any one of claims 142-168, wherein the precipitate generated in (e) is subsequently reduced with hydrogen gas to form a transition metal.

170. The method of any one of claims 142-168, wherein the precipitate generated in (e) is subsequently reduced with carbon/carbon monoxide to form a transition metal.

171. The method of claim 169 or 170, wherein the reduction is performed in the presence of CaCO₃.

172. The method of any one of claims 142-168, wherein the precipitate generated in (e) is subject to an electrowinning process for extracting transition metals.

173. A method for extracting a transition metal ion-containing precipitate comprising:
a. providing a salt solution;
b. performing electrochemical reactions in the salt solution to produce a solution of lower pH and a solution of higher pH;
c. providing a silicate-containing material containing transition metal ions, e.g. silicate-containing Ni laterites;
d. treating the silicate-containing material with the solution of lower pH to dissolve at least a portion of the silicate-containing material and generate a solution with higher pH;
e. treating the treated silicate-contain material generated in (d) with the solution of higher pH to dissolve at least a portion of the silicate-containing material and generate a second solution with lower pH;
f. combining the solution generated in (d) with at least a portion of the solution generated in (e) to form the transition metal ion-containing precipitate and a second salt solution; and
g. recycling the salt solution formed in (f) by adding the salt solution to (b).

174. The method of claim 173, wherein the silicate-containing material comprises less than 30% Si by mass.

175. The method of claim 173, wherein the silicate-containing material comprises a ratio of O to Si greater than or equal to 3:1.

176. The method of claim 173, wherein the precipitate comprises XₐY_{b}Z_{c} wherein
X and Y are selected from the group consisting of Na, K, Li, Ca, Mg, Fe, Ni, Co, Mn, Cu, Al, and Si;
Z is selected from the group consisting of O, OH, Cl, Br, I, F, S, N, SO₄, and ClO₄; and
a, b, and c each range from 0.001 to 99.999.

177. The method of claim 173, wherein the salt solution comprises alkali cations and chloride anions.

178. The method of claim 173, wherein the salt solution comprises alkali cations and sulfate anions.

179. The method of any of claims 177-178, wherein additional salts are added to the salt solution.

180. The method of claim 173, wherein a cell comprising a cathode, a separator, and an anode is used in (b).

181. The method of claim 173, wherein a cell stack comprising repeating units of a cathode, a separator, and an anode is used in (b), and the units are electrically connected in series.

182. The method of claim 173, wherein a cell comprising a cathode, a separator, an anode, and a number of repeating units in between the separator and anode consisting of a bipolar membrane and a separator is used in (b).

183. The method of any one claims 180-182, where the cathode produces hydrogen gas and the anode consumes hydrogen gas.

184. The method of any one claims 180-183, wherein the cathode comprises Pt, Pd, Ni, Ir, Rh, Co, Ru, Fe, Mn, Ti, Zr, Au, Ag, Cu, Pb, Bi, and/or carbon.

185. The method of any one claims 180-184, wherein the anode comprises Pt, Pd, Ni, Ir, Iridium Oxide, Rh, Co, Ru, Ruthenium Oxide, Fe, Mn, Ti, Zr, Au, Ag, Cu, Pb, Bi, and/or carbon.

186. The method of any one claims 180-185, wherein the separator comprises an ion exchange membrane or a diaphragm.

187. The method of any one of claims 180-186, wherein an electrical current between 10 and 2000 mA/cm² is applied.

188. The method of any one of claims 180-187, wherein the salt solution is flowed at a rate of 0.1 to 100 mL/min/cm² through the cathode and anode compartments.

189. The method of any one of claims 173-188, wherein the salt solution is pH 0-14.

190. The method of any one of claims 173-188, wherein the salt solution is pH 7-14.

191. The method of any one of claims 173-190, wherein the pH of the solution of lower pH is 0-7.

192. The method of any one of claims 173-191, wherein the pH of the solution of higher pH is 7-14.

193. The method of any one of claims 173-192, wherein the solution of lower pH is stored and/or recirculated to the electrochemical cell prior to exposure to the silicate-containing material.

194. The method of any one of claims 173-193, wherein the solution of higher pH is stored and/or recirculated to the electrochemical cell prior to exposure to the solution generated in (d).

195. The method of any one of claims 173-194, wherein the solution generated in (d) is separated from remaining silicate-containing material before (f) and/or the solution generated in (e) is separated from remaining silicate-containing material before (f).

196. The method of claim any one of claims 173-194, wherein the solution generated in (d) is not separated from remaining silicate-containing material before (f) the solution generated in (e) is not separated from remaining silicate-containing material before (f).

197. The method of any one of claims 173-196, wherein carbonate salt is added to salt solution to precipitate cations.

198. The method of any one of claims 173-197, wherein the salt solution is contacted with CO₂ prior to recirculation to the electrochemical cell.

199. The method of any one of claims 173-198, wherein the precipitate generated in (f) is a substantially amorphous material, a crystalline material, or a mixture thereof.

200. The method of any one of claims 173-199, wherein the precipitate generated in (e) is subsequently reduced with hydrogen gas to form a transition metal.

201. The method of any one of claims 173-199, wherein the precipitate generated in (e) is subsequently reduced with carbon/carbon monoxide to form a transition metal.

202. The method of claim 200 or 201, wherein the reduction is performed in the presence of CaCO₃.

203. The method of any one of claims 173-199, wherein the precipitate generated in (e) is subject to an electrowinning process for extracting transition metals.
